(19) United States
(12) Patent Application Publication
(10) Pub. No.: US 2025/0133038 A1
(43) Pub. Date: Apr. 24, 2025

(54) CONTEXT-AWARE DIALOGUE SYSTEM

(71) Applicants: Li Shang, Shanghai (CN); Qin Lv, Boulder, CO (US); Yuhu Chang, Shanghai (CN); Zhenyu Xu, Shanghai (CN); The Regents of the University of Michigan, Ann Arbor, MI (US)

(72) Inventors: Li Shang, Shanghai (CN); Qin Lv, Boulder, CO (US); Yuhu Chang, Shanghai (CN); Zhenyu Xu, Shanghai (CN); Robert P. Dick, Chelsea, MI (US)

(21) Appl. No.: 18/924,655

(22) Filed: Oct. 23, 2024

Related U.S. Application Data
(60) Provisional application No. 63/545,294, filed on Oct. 23, 2023.
(60) Provisional application No. 63/645,657, filed on May 10, 2024.

(51) Int. Cl. H04L 51/02; G06V 40/16; G06V 40/18; G10L 15/26; G10L 25/63

(52) U.S. Cl. CPC H04L 51/02; G06V 40/168; G06V 40/18; G10L 15/26; G10L 25/63

(57) ABSTRACT

A method for generating personalized responses in a conversation with a user includes generating real-time contexts capturing an environment of the user over time, including generating a particular real-time context based on a first data stream corresponding to a first modality in an environment of the user and a second data stream corresponding to a second modality in the environment of the user, generating historical contexts based on the real-time contexts, in response to receiving a conversational cue provided by the user, generating a current real-time context based on data corresponding to the first modality and the second modality in a current environment of the user, and generating, based on the current real-time context, a personalized response to the conversational cue, including identifying, based on the current real-time context, relevant user information, including identifying one or more relevant historical contexts, and generating the personalized response using the relevant user information.

### CROSS-REFERENCE TO RELATED APPLICATIONS

This application claims the benefit of U.S. Provisional Application entitled “Personal Context-aware Dialogue System on Smart Eyewear,” filed on Oct. 23, 2023, and assigned Ser. No. 63/545,294, and U.S. Provisional Application entitled “Context-aware Dialogue System,” filed on May 10, 2024, and assigned Ser. No. 63/645,657, the entire disclosures of both of which are hereby expressly incorporated by reference.

### BACKGROUND OF THE DISCLOSURE

### Field of the Disclosure

The disclosure relates generally to a context-aware dialogue system.

### Brief Description of Related Technology

Natural language processing (NLP) technology has been used to enable interaction between computers and human beings. However, the limited linguistic and cognitive capabilities of NLP creates major barriers to personalized dialogues. Recent advances in large language models (LLMs) such as ChatGPT (based on the GPT-3.5 LLM model) and GPT-4 have opened the possibility of supporting natural and human-like conversations. Pre-trained on massive amounts of text data, LLMs have the ability to encode a vast amount of world knowledge. These capabilities allow LLMs to generate coherent and diverse responses; this enhances natural conversation. Additionally, through supervised instruction fine-tuning and reinforcement learning with human feedback, LLMs can be adapted to follow human instructions while avoiding creating harmful or inappropriate content. However, current chatbot systems lack the capability to serves as personalized companions and do not enable human-like relationships between users and chatbots and provide companion-like conversational experiences to the users.

### SUMMARY OF THE DISCLOSURE

In accordance with one aspect of the disclosure, a method for generating personalized responses in a conversation with a user includes generating, by one or more processors, a plurality of real-time contexts capturing an environment of the user over time, including generating a particular real-time context, among the plurality of real-time contexts, based on i) a first data stream corresponding to a first modality in an environment of the user and ii) a second data stream corresponding to a second modality in the environment of the user, wherein the second modality is different from the first modality, and wherein respective real-time contexts, among the plurality of real-time contexts, correspond to different points in time, generating, by the one or more processors, a plurality of historical contexts based on the plurality of real-time contexts, in response to receiving a conversational cue provided by the user, generating, by the one or more processors, a current real-time context based on data corresponding to the first modality and the second modality in a current environment of the user, generating, by the one or more processors based on the current real-time context, a personalized response to the conversational cue, wherein generating the personalized response includes identifying, based on the current real-time context, relevant user information, including identifying one or more relevant historical contexts from among the plurality of historical contexts, and generating the personalized response to the conversational cue using the relevant user information, and causing, by the one or more processors, the personalized response to be provided to the user.

In accordance with another aspect of the disclosure, a method for generating personalized responses in a conversation with a user includes generating, by one or more processors, a plurality of real-time contexts, including generating a particular real-time context, among the plurality of real-time contexts, based on i) a first data stream corresponding to a first modality in an environment of the user and ii) a second data stream corresponding to a second modality in the environment of the user, wherein the second modality is different from the first modality, and wherein respective real-time contexts, among the plurality of real-time contexts, correspond to different points in time, generating, by the one or more processors, user information, including generating a plurality of historical contexts based on one or both of i) the plurality of real-time contexts or ii) previous conversations with the user, wherein respective historical contexts, among the plurality of historical contexts, include one or both of i) summaries of daily events associated with the user or ii) summaries of the previous conversations with the user, and generating, based on the plurality of historical contexts, a plurality of user profiles, wherein a particular user profiles, among the plurality of user profiles, includes information regarding a particular aspect of the user, in response to receiving a conversational cue from the user, generating, by the one or more processors, a current real-time context based on data corresponding to the first modality and the second modality in a current environment of the user, generating, based on the current real-time context, a personalized response to the conversational cue, including identifying, based on the current real-time context, relevant user information, including identifying one or both of i) one or more relevant historical contexts from among the plurality of historical contexts or ii) one or more relevant user profiles from among the plurality of user profiles, and generating the personalized response to the conversational cue using the relevant user information, and causing, by the one or more processors, the personalized response to be provided to the user.

In accordance with yet another aspect of the disclosure a system comprises a first sensor configured to generate a first data stream corresponding to a first modality in an environment of a user, a second sensor configured to generate data a second data stream corresponding to a second modality in the environment of the user, wherein the second modality is different from the first modality, and one or more processors configured to generate a plurality of real-time contexts capturing an environment of the user over time, including generating a particular real-time context, among the plurality of real-time contexts capturing the environment of the user over time, based on i) the first data stream obtained from the first sensor and ii) the second data stream obtained from the second sensor, generate a plurality of historical contexts based the plurality of real-time contexts capturing the environment of the user over time, in response to receiving a conversational cue provided by the user, generate a current real-time context based on data corresponding to the first modality and the second modality in a current environment of the user, generate, based on the current real-time context, a personalized response to the conversational cue, wherein generating the personalized response includes identifying, based on the current real-time context, one or more relevant historical contexts, among the plurality of historical contexts, that are relevant to the conversational cue provided by the user, and generating the personalized response to the conversational cue using the one or more relevant historical contexts, and cause the personalized response to be provided to the user.

In connection with any one of the aforementioned aspects, the systems, devices and/or methods described herein may alternatively or additionally include or involve any combination of one or more of the following aspects or features. The first data stream corresponding to the first modality comprises image data visually depicting a scene in the environment of the. The second data stream corresponding to the second modality comprises audio data reflecting audio environment of the user and sound produced by the user. The image data comprises images of the environment of the user captured at predetermined intervals of time. The audio data comprises a continuous audio stream capturing the audio environment of the user and the sound produced by the user. Generating the particular real-time context includes generating, using a vision language model, a textual description of the scene based on the image data, transcribing, using a speech recognition model, the audio data to generate a textual representation of the audio environment of the user and the sound produced by the user, and generating the particular real-time context based on i) the textual description of the scene and ii) the textual representation of the audio data. Generating the particular real-time context further includes inferring, from one or both of the textual description of the scene and the textual representation of the audio data, a location of the user and an activity of the user, and generating the particular real-time context to include information indicative of the location of the user and the activity of the user. Inferring the location of the user and the activity of the user includes generating a prompt based on the textual description of the scene and the textual representation of the audio environment of the user and the sound produced by the user, and providing the prompt to a language model to infer the location of the user and the activity of the user. The image data further includes data indicative of one or both of i) facial appearance of the user or ii) gaze direction of one or both eyes of the user. The method further includes detecting, by the one or more processors, an emotional state of the user based on analyzing one or both of i) one or both of facial appearance or gaze direction of one or both eyes of the user obtained from the image data or ii) information indicative of user emotion obtained from the audio data, and generating, by the one or more processors, the particular real-time context to further include information indicative of the emotional state of the user. Respective ones of the plurality of historical contexts include one or both of i) summaries of daily events of the user or ii) summaries of previous conversations with the user. Generating the plurality of historical contexts includes clustering, based on similarities between the real-time contexts among the plurality of real-time contexts, subsets of the real-time contexts into respective daily events, generating, based on the subsets of the real-time contexts clustered into the respective daily events, respective summaries of the daily events, and generating the historical contexts to include the respective summaries of the daily events. Generating the plurality of historical contexts includes separating previous conversations with the user into conversation sessions, generating respective conversation summaries of the conversation sessions, and generating the historical contexts to include the respective conversation summaries of the conversation sessions. The method further includes generating, by the one or more processors, respective sets of one or more indices for respective historical contexts, among the historical contexts, the one or more indices generated for a particular historical context including one or more of i) a temporal index indicative of a time associated with the particular historical context, ii) a spatial index indicative of a location associated with the particular historical context, and iii) a semantic index indicative of semantic content associated with the particular historical context, storing, by the one or more processors in a database, the plurality of historical contexts in association with corresponding ones of the respective sets of one or more indices, and performing associative retrieval based on the respective sets of one or more indices associated with the historical contexts in the database to identifying the one or more relevant historical contexts. The method further comprises generating, by the one or more processors, a plurality of user profiles based on the plurality of historical contexts, wherein a particular user profiles, among the plurality of user profiles, includes a textual description of a particular aspect of the user. Identifying the relevant user information further includes identifying one or more relevant user profiles from among the plurality of user profiles. Generating the plurality of user profiles includes generating a new user profile based on a historical context among the plurality of historical contexts, querying a database, that sores user profiles, to determine whether there is a stored user profile that satisfies a similarity criteria with the new user profile, in response to determining that there is a stored profile that satisfies the similarity criteria with the new user profile, updating the stored user profile based on the new user profile, and in response to determining that there is no stored user profile that satisfies the similarity criteria with the new user profile, storing the new user profile in the database as a separate new user profile. Generating the personalized response includes generating a dialogue strategy based on the current real-time context, identifying the relevant user information based on the dialogue strategy, and generating the personalized response based on the current real-time context and the relevant user information identified based on the dialogue strategy. Generating the plurality of historical contexts includes clustering, based on similarities between the real-time contexts among the plurality of real-time contexts, subsets of the real-time contexts into respective daily events, generating, based on the subsets of the real-time contexts clustered into the respective daily events, respective summaries of the daily events, separating previous conversations with the user into conversation sessions, generating respective summaries of the conversation sessions, and generating the historical contexts to include i) the respective summaries of the daily events and ii) the respective summaries of the conversation sessions.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates an example context-aware dialogue system that may be configured to generate personalized responses based various contexts of a user, in accordance with an example.

FIG. 2 illustrates an example implementation of the context-aware dialogue system of FIG. 1, in accordance with an example.

FIG. 3 is a block diagram of a personalized dialogue system that may utilize a context-aware dialog system, in accordance with an example.

FIG. 4 illustrates an example process that may be implemented by a real-time context capture engine to infer activity and location of a user, in accordance with an example.

FIG. 5 illustrates a process that may be implemented by a historical context extraction engine to generate an event summary, in accordance with an example.

FIG. 6 illustrates a process that may be implemented by a historical context extraction engine to generate a conversation summary, in accordance with an example.

FIG. 7 illustrates a process that may be implemented by a user profile distillation engine to generate a user profile, in accordance with an example.

FIG. 8 illustrates operation of a dialogue strategy agent, in accordance with an example.

FIG. 9 illustrates operation of an information retrieval agent, in accordance with an example.

FIG. 10 illustrates operation of a personalized response generation engine, in accordance with an example.

FIG. 11 illustrates an example eyewear device that may be used with a personalized dialogue system, in accordance with an example.

FIG. 12A is a bar chart illustrating performance of different response generation methods in terms of grounding, relevance, personalization, and engagement score, in accordance with an example.

FIG. 12B is a bar chart illustrating calculated percentage of a number of multiple factors that lead to good grounding, in accordance with an example.

FIG. 13 illustrates dialogues between a user and different response generation systems, in accordance with an example.

FIGS. 14A-B are bar charts illustrating average evaluation scores of participants in a first phase and a second phase, respectively, of a pilot study, in accordance with an example.

FIGS. 15A-B are bar charts illustrating calculated daily percentage contribution of factors to establishing common ground during a first phase and a second phase, respectively, of a pilot study, in accordance with an example.

FIG. 16 illustrates a real-time context-aware case when a real-time context factor plays a significant role in a dialogue, in accordance with an example.

FIG. 17 illustrates a historical context-aware case, showing that historical context can ensure that the conversations are coherent and consistent over time, in accordance with an example.

FIG. 18 illustrates a user profile context-aware case, showing that user profile allows a context-aware dialogue system to understand the user's personality traits, social background, preferences, and habits, in accordance with an example.

FIG. 19 illustrates a dialogue in which a user shares anxiety about job hunting with a context-aware dialogue system, in accordance with an example.

FIG. 20 illustrates a dialogue in which a context-aware dialogue system expresses excitement and actively guesses a vacation location of a user based on previous conversations, in accordance with an example.

FIG. 21 illustrates a dialogue in which a context-aware dialogue system assists a user in gaining knowledge, in accordance with an example.

FIG. 22 illustrates a dialogue in which a user asks a context-aware dialogue system about foods that can help with sleep, in accordance with an example.

FIG. 23 depicts a method for generating personalized responses in a conversation with a user, in accordance with an example.

FIG. 24 is a block diagram of a computing system with which aspects of the disclosure may be practiced, in accordance with an example.

The embodiments of the disclosed systems and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

According to aspects of the present disclosure, methods and system are provided that utilize powerful language modeling capabilities of large language models (LLMs) along with context and user profile information to provide LLM-based chatbots that may serve as personal companions in daily life. In an aspect, a context-aware dialogue system may be used with a portable or wearable device, such as smart eyewear, that may be carried or worn by a user and may be equipped with one or more sensors (e.g., cameras) and one or more microphones to capture multiple modalities of data, such as video and audio data, descriptive of the environment of the user. Such video and audio data may be captured as the user goes about daily life over time, for example. Based on the captured video and audio data, the context-aware dialogue system may generate real-time contexts capturing the environment of the user over time. In some examples, data corresponding to modalities other than video and/or audio may be used in generating the real-time contexts. For example, data corresponding to various modalities such as visual, auditory, textual, speech, textile etc., modalities or combinations thereof, may be collected and used. The real-time contexts may include, for example, inferred locations and activities of the user. In some examples, the real-time context may also include information indicative of an emotional state of the user. The context-aware dialogue system may detect the emotional state of the user based on facial appearance and/or gaze direction of one or both eyes of the user determined based on image data obtained via an inward-facing camera that may be provided on the portable device (e.g., smart eyewear) of the user. The facial appearance and/or gaze direction may be used to track the facial expression and eye movements of the user to determine emotional state indicative of happiness, sadness, fear, anger, disgust, surprise, etc. experienced by the user. Additionally, or alternatively, the context-aware dialogue system may detect the emotional state of the user based on the audio data obtained via the microphone of portable device (e.g., smart eyewear) of the user. For example, the audio data may include utterances of the user, and the emotional state may be inferred based on content, intonation, sound level, arousal level etc. of the utterances of the user.

The context-aware dialogue system may use the plurality of real time contexts to generate user information that may be used for generating personalized responses during subsequent conversations with the user. For example, the context-aware dialogue system may generate a plurality of historical contexts based on subsets of the plurality of real-time contexts. The historical contexts may be generated, for example, based on real-time contexts that are clustered into daily events according to the inferred locations and/or activities of the user. The historical contexts may include summaries of the daily events. The historical contexts may also include summaries of previous conversations that the user may have had with the context-aware dialogue system over time. In an example, the historical contexts may be indexed using a multidimensional indexing scheme (e.g., in temporal, special, and semantic dimensions) to allow for efficient retrieval of relevant historical contexts during a conversation with the user. In some aspects, the context-aware dialogue system may further distill the historical contexts into user profiles that include descriptions (e.g., textual descriptions) of various aspects of the user, such as aspects of personality, habits, preferences, social background, etc. of the user. The user profiles may be updated and enhanced over time. In an example, the context-aware dialogue system may implement an update scheme to merge similar user profiles generated over time.

In various aspects, the user information generated based on real-time contexts over time may enhance personalization of responses generated by the context-aware dialogue system during subsequent conversations with the user. In an example, in response to receiving a conversational cue provided by the user, the context-aware dialogue system may generate a current real-time context based on a current environment of the user. The context-aware dialogue system may then generate a personalized response to the conversational cue based on the current real-time context of the user. Generating the personalized response may include identifying, based on the current real-time context, relevant user information, including one or more relevant historical contexts and/or one or more user profiles that are relevant to the conversational cue received from the user. In some examples, the context-aware dialogue system may first decide a response strategy and/or conversation direction based on the current real-time context of the user, and may then identify the user information that may be relevant to the response strategy and/or the conversation direction. The context-aware dialogue system may use the relevant user information along with the current real-time context to generate the personalized response to the conversational cue provided by the user. For example, the context-aware dialogue system may use the relevant user information along with the current real-time context to generate a prompt for a large language model (LLM), and may obtain the personalized response by prompting the LLM. In other examples, the personalized response may be generated based on the relevant user information and the current real-time context in other suitable manners. The generated response may be presented to the user, for example via a speaker provided on, or connected to (e.g., via Bluetooth), the portable device (e.g., smart eyewear) of the user. In at least some aspects, these and other techniques described herein may enable the context-aware dialogue system to build common ground with the user, e.g., by understanding context and objects of interest, and learning personality and goals, of the user, and to provide highly personal and human-like interaction and daily companionship to the user. The context-aware dialogue system may thus be used in various applications, such as emotional support and/or personal assistance applications. In other examples, the context-aware dialogue system may be used in other suitable personal dialogue applications.

Despite impressive human-like language capabilities, current LLMs do not establish common ground, preventing current LLM-based chatbots from being personal companions. Based on research in linguistics, psychology, and Human-Computer Interaction (HCl), establishing common ground is useful for successful and meaningful conversations. This common ground can stem from shared personal experiences, interests, and other factors. For example, when initiating a dialogue with other people, humans typically either ask questions to establish common ground or presuppose certain common ground already exists. It is challenging for an LLM to establish a mutual understanding with a person.

According to aspects of the present disclosure, common ground between a chatbot system and its user is considered as a key enabler for true companionship. The chatbot system may comprise an LLM-based dialogue system, for example. In aspects, a chatbot system may be hosted on smart eyewear that can see what its user sees and hear what its user hears. As user-related knowledge accumulates over time, that chatbot's common ground with the user improves, enabling better-personalized dialogue. In-lab and pilot studies have been performed to evaluate the quality of common ground relevant information captured by the chatbot system, i.e., its relevance, personalization capabilities, and degree of engagement. The experimental results indicate that the disclosed chatbot system exhibits an understanding of its user's historical experiences and personalities, leading to better engagement and more personal chatting experiences, thus making the chatbot a better companion to its user.

The common ground between humans is usually implicit and subjective. Therefore, it may not be practical to expect users to provide common ground information explicitly. Also, LLMs are generally not equipped to perceive a user's context, e.g., their physical surroundings or daily experiences. Without such personal context, LLMs struggle to comprehend a user's visual surroundings, speech, daily events, and behavior (e.g., personality traits, habits, etc.). This prevents the conventional LLMs from establishing common ground with users.

Aspects of the present disclosure provide personal context awareness for establishing common ground that may be used with LLMs. Such personal context may enable LLM-based dialog systems establish common ground with users. In various aspects, different types of personal context are used to contribute in various ways to personalized LLM-based dialog systems responses.

In various aspects, ubiquitous personal context enables establishment of common ground between LLM-based dialogue systems and their users. Furthermore, such personal context enables more personalized responses from a dialogue system. In aspects, an LLM-based smart eyewear system is provided that may achieve ubiquitous personal context capturing and use. In aspects, personal context may be divided into multiple categories in the temporal dimension. For example, personal context may be divided into three categories: real-time context, historical context, and user profiles. Real-time context may refer to momentary semantics inferred from the user's ongoing speech and visual surroundings. These semantics may enable LLMs to understand the meanings of the user's speech and visual perceptions, enabling the generation of appropriate responses. Historical context may include a summary of the past real-time context time series. Historical context may organize the user's daily events and dialogue contents by clustering the real-time contexts into temporal units. This information may enable LLMs to maintain the coherence and continuity of the dialogue, and enables it to avoid repeating or contradicting previous statements. User profiles may include distilled historical information related to the user's personality, habits, and preferences, which are revealed during interaction with the dialogue system. User profiles may enable LLMs to incorporate additional human-like qualities by adapting to the user's personality and long-term goals, resulting in more consistent and anthropomorphic responses, in at least some examples.

Aspects of the present disclosure utilize personal context and a human evaluation metric ground score to assess the ability of an LLM-based dialogue system to reach mutual understanding. Aspects of the present disclosure may thus provide a context-aware dialogue system (sometimes referred to herein as “OS-1”) that may support various personal companionship applications.

According to aspects of the present disclosure, an always-available smart eyewear LLM based personal dialogue system is provided. The system may capture the user's multi-modal surroundings on-the-fly, may generate personal context, and may engage in personalized conversation with the user. One of the advantages of the system is its ability to achieve the above without introducing any additional cognitive load or interaction requirements on users, thereby enhancing the user experience under various HCl scenarios.

Aspects of the present disclosure provide a process to capture, accumulate, and refine the personal context from user multi-modal contexts and dialogue histories, and a multi-dimensional indexing and retrieval mechanism that integrates multiple personal contexts to enable personalized responses. The process may facilitate dynamic adaptation to the user's surroundings, experiences, and traits, enabling an engaging and customized conversation experience.

An in-lab study and a pilot study have been conducted to evaluate the impact of using personal context within the dialogue system. The results show superior performance of the disclose system in gradually improving grounding.

The context-aware dialogue system of the present disclosure may be a personal, human-like companion that may accompany a person in daily life. The context-aware dialogue system may be used with a portable device that may be carried by a user in a chest pocket, for example, or may be hosted on another portable device, such as smart glasses that can be worn by the user. The context-aware dialogue system may be equipped with or have access to one or more sensors (e.g., cameras) and one or more microphones that may capture various aspects in an environment of the user. Thus, the context-aware dialogue system may see what the user sees, may hear what the user hears, and may chat with the user using an earbud or other speaker that may be provided with the portable device. The context-aware dialogue system may provide human-like interaction aware of the user's feelings and experiences, such as joys and sorrows during work and leisure. Through day-by-day interactions, the context-aware dialogue system may gradually learn the user's personality, preferences, and habits. The context-aware dialogue system may thus offer companionship, emotional support, and assistance to the user.

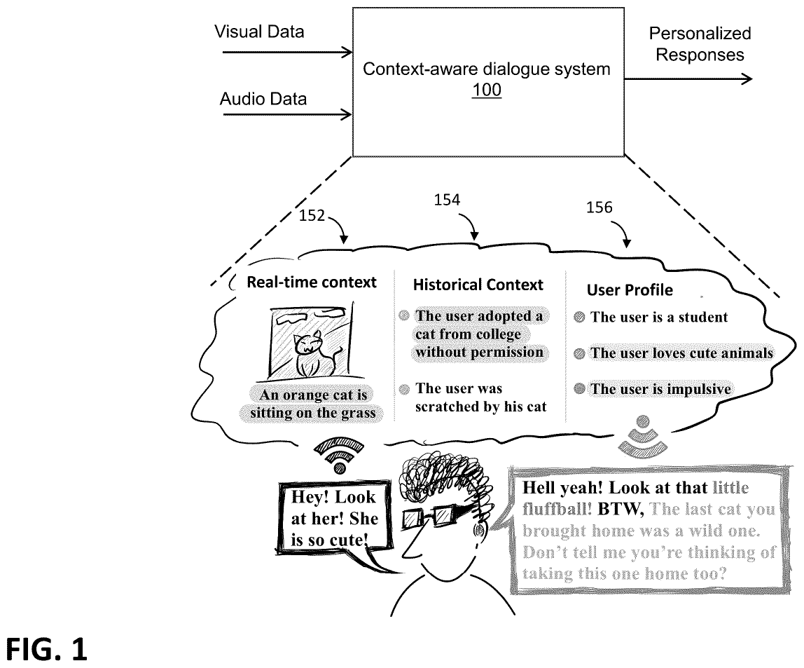

FIG. 1 illustrates an example context-aware dialogue system 100 (sometimes referred to herein as “OS-1”) that may be configured to generate personalized responses based on various contexts of the user. The context-aware dialogue system 100 may be used in example environments as described above, for example. As illustrated in FIG. 1, the various contexts that may be used to generate personalized responses by the context-aware dialogue system 100 may include i) a real-time context 152 (sometimes also referred to herein as “episodic context”) that may be generated by the context-aware dialogue system 100 based on visual and/or audio data detailing current environment of the user, ii) a historical context 154 generated by the context-aware dialogue system 100 based on previous real-time contexts obtained from the user and/or previous dialogues with the user, and ii) user profile information 156 that may be generated and maintained by the context-aware dialogue system 100 for the user.

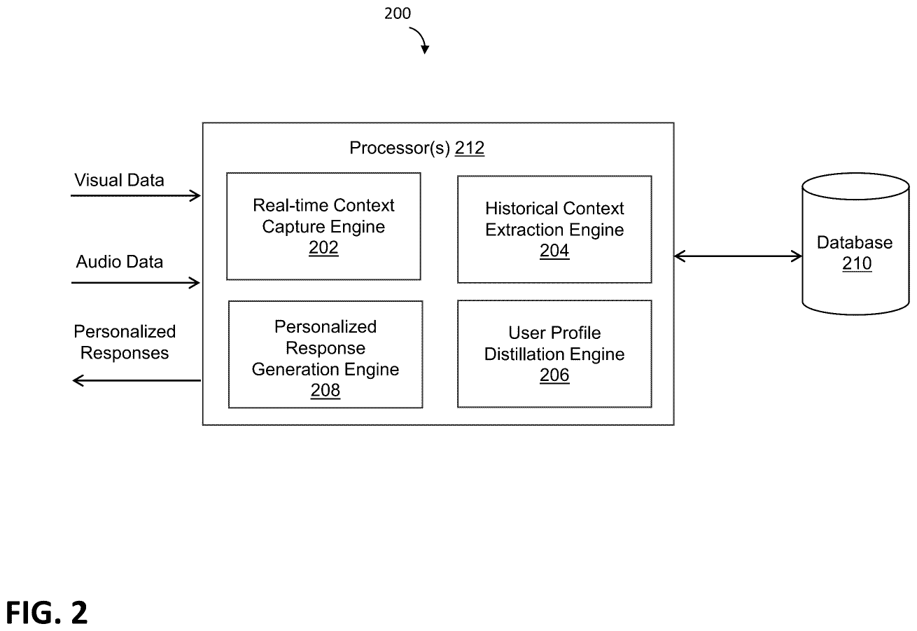

FIG. 2 illustrates an example implementation of a context-aware dialogue system 200. In an example, the context-aware dialogue system 200 corresponds to the context-aware dialogue system 100 of FIG. 1. In the implementation illustrated in FIG. 2, the context-aware dialogue system 200 includes a real-time context capture engine 202, a historical context extraction engine 204, a user profile distillation engine 206, and a personalized response generation engine 208. In other examples, the context-aware dialogue system 200 may be implemented in other suitable manners. For example, the context-aware dialogue system 200 may omit one or more of the engines illustrated in FIG. 2 and/or may include one or more additional engines not illustrated in FIG. 2. The context-aware dialogue system 200 may also include or be coupled to a database 210. The database 210 may store various context information, such as historical context and/or user profile information. The database 210 may be a vector database, for example. In another example, the database 210 may be a suitable type of database other than a vector database. The context-aware dialogue system 200 may store various user information, such as historical context and/or user profile information, generated for a user in the database 210, and may subsequently retrieve relevant user information from the database 210 to generate context-aware responses when conversing with the user.

In an aspect, the context-aware dialogue system 200 is an LLM-based chatbot system aware of the common ground with its users. The context-aware dialogue system 200 may capture, over time, one or more data modalities, such as video and audio data, descriptive of an environment of a user, may gradually build common ground with the user based on the captured data, and may use the common ground to generate and provide personalized dialogue responses to the user at proper times. In an example, the context-aware dialogue system 200 may be implemented by one or more processors 212. The one or more processors 212 may reside at least partially on a smart eyewear device (e.g., smart glasses) and/or may interact with a smart eyewear device to obtain visual and audio data from the smart eyewear device and provide conversational responses to the user via an audio output on the smart eyewear device. For example, each of the real-time context capture engine 202, the historical context extraction engine 204, the user profile distillation engine 206, and the personalized response generation engine 208 may be implemented at least partially on one or more processors 212 residing on a smart eyewear device and/or residing one or more remote servers that may be communicatively coupled to the smart eyewear device over a communication network. In some examples, the context-aware dialogue system 200 may be implemented partially on one or more processors residing on a smart eyewear device and one or more processors residing in on one or more servers in the cloud. In some examples, each of one or more of the real-time context capture engine 202, the historical context extraction engine 204, the user profile distillation engine 206, or the personalized response generation engine 208 may be implemented partially on one or more processors of a smart eyewear device and partially in the cloud.

It is noted that although the context-aware dialogue system 200 is generally described herein in the context of smart eyewear devices, the present disclosure is not limited to smart eyewear devices. In some examples, the context-aware dialogue system 200 may be implemented on and/or interact with devices other than eyewear devices, such as various wearable devices or other devices that the user may wear or carry during daily activities. Generally, the context-aware dialogue system 200 may be implemented at least partially on any device that can perceive and obtain data related to a user's environment, such as visual and/or audio environment, in various examples.

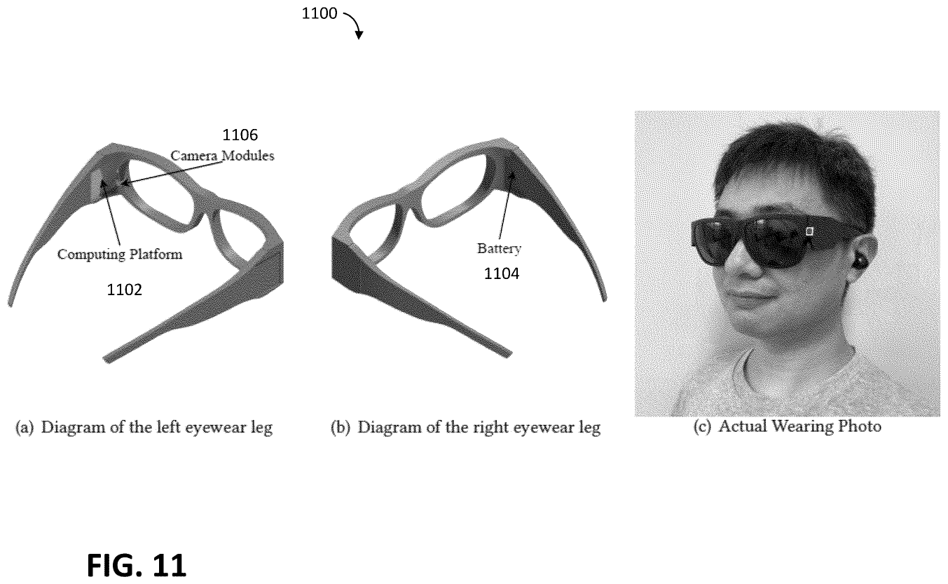

In an example, the smart eyewear device may include one or more built-in sensors (e.g. cameras) and one or more microphones. The one or more sensors may include a forward-facing sensor (sometimes referred to herein as a “world camera”) that faces forward with respect to field of view of the user. The world camera may capture information (e.g., images, videos, etc.) descriptive of what is seen by the user. In some examples, the one or more sensors may additionally include an inward-facing sensor (sometimes referred to herein as “eye camera”) that faces the eyes of the user. The eye camera may be configured to capture facial expression of the user and information indicative of movement, gaze direction, and/or expression of one or both eyes of the user and/or facial appearance of the user. An example smart eyewear device and example sensors and microphones that may be built into or otherwise provided with the smart eyewear device, according to an example, is described in more detail below with reference to FIG. 11.

The smart eyewear may perceive the user's in-situ visual and audio signals through the one or more built-in sensors and microphones. In an aspect, the smart eyewear device may transfer the visual and audio signals to the cloud on the fly. These two types of information may be used by the context-aware dialogue system 200 to understand the user's ongoing status. For example, the context-aware dialogue system 200 (e.g., the real-time context capture engine 202) may utilize a vision-language model (e.g., LLaVA) and a speech recognition model (e.g., Whisper), that may be deployed in the cloud, to infer the semantic description of images and transcribe voice data into text. In some aspects, the context-aware dialogue system 200 (e.g., the real-time context capture engine 202) may combine the visual and audio data modalities, and may infer the user's current activity, location, and other information inferred from the user's surroundings based on the combined visual and audio data modalities. The context-aware dialogue system 200 (e.g., the real-time context capture engine 202) may thus generate a real-time context based on the obtained video and audio data and/or the inferred information.

In some examples, the context-aware dialogue system 200 (e.g., the real-time context capture engine 202) may also identify emotional state of the user, and may generate the real-time context to further include information indicative of the emotional state of the user. Emotion and mood awareness may be useful for personal conversations. In an example, the context-aware dialogue system 200 may implement multi-modal emotion and mood recognition techniques that leverage both visual and voice modalities. The visual modality sources may include the visual content captured by the forward-facing world camera, and image data captured by the inward-facing eye camera. The context-aware dialogue system 200 (e.g., the real-time context capture engine 202) may be configured to perform run-time emotion detection based on the visual modality. Example emotion detection systems and methods that may be implemented by the context-aware dialogue system 200 are described in U.S. patent application Ser. No. 18/101,856, entitled “Detecting Emotional State of a User Based on Facial Appearance and Visual Perception Information,” filed on Jan. 26, 2023, the entire disclosure of which is hereby incorporated herein by reference. On the other hand, voice modality is the direct measure of conversation-dependent emotion and mood conditions. The modality of speech introduces nuances and intonations that can greatly influence the emotional tone and context, often complementing or even contrasting the textual content. To this end, in aspects of the present disclosure, the context-aware dialogue system 200 may integrate both textual and speech modalities to enable accurate emotion and mood detection using LLMs. The context-aware dialogue system 200 may thus perform visual-voice-based multi-modal recognition to determine human emotion and mood on the fly. In an example, the emotion and mood information may then be included as part of real-time contexts generated for the user.

The context-aware dialogue system 200 (e.g., the historical context extraction engine 204) may generate and maintain the user's historical information. The user's historical information may be used to ensure long-term coherence and consistency in dialogues with the user. In an aspect, the context-aware dialogue system 200 (e.g., the historical context extraction engine 204) may implement a clustering method that extracts the relevant information, such as daily events, from the accumulated real-time contexts, thus forming the historical context. The clustering method may remove redundancy between inter-real-time contexts, and may produce event-level descriptions that may then be summarized. In some aspects, as explained in more detail below, indexing methods along temporal, spatial, and semantic dimensions may be used to facilitate efficient retrieval of historical contexts from different perspectives.

The context-aware dialogue system 200 (e.g., the user profile distillation engine 206) may analyze the historical context of a user to form a user profile that includes information related to user's personality, preferences, and life habits, for example. Such information may enable the context-aware dialogue system 200 to better understand users' profiles. In some situations, inference of the user profile may be biased or contain errors due to limited interactions. In an aspect, the context-aware dialogue system 200 (e.g., the user profile distillation engine 206) may implement an update scheme that can revise the current user profile based on the historical context and past user profiles.

The context-aware dialogue system 200 (e.g., the personalized response generation engine 208) may generate personalized responses during conversations between the context-aware dialogue system 200 and the user. In an aspect, whenever a user starts a conversation, the personalized response generation engine 208 retrieves the historical context from temporal, spatial, and semantic dimensions based on the current real-time context. The context-aware dialogue system 200 (e.g., the personalized response generation engine 208) may also retrieve the relevant user profile. In an example, the context-aware dialogue system 200 (e.g., the personalized response generation engine 208) may utilize multi-LLM agents to generate search queries for personal context dynamically based on real-time context during conversations. The context-aware dialogue system 200 (e.g., the personalized response generation engine 208) may thus utilize personal context containing the real-time context, the retrieved historical context, and the retrieved user profile information to form an LLM prompt, providing personalized responses that may be transmitted from the cloud to the smart eyewear's speakers.

In-lab experiments and in-field pilot studies have been conducted to evaluate the ability of the context-aware dialogue system 200 to establish common ground using the captured and refined personal contexts. In various aspects, the ability to establish common ground enables the context-aware dialogue system 200 to facilitate better conversation with the user. In aspects, a human evaluation metric (also sometimes referred to herein as a “grounding score”) may be used to evaluate how well the context-aware dialogue system 200 can build up common ground with its users. Further, more fine-grained metrics, such as relevance, personalization, and engagement score, may be used to evaluate the relevance of the responses generated by the context-aware dialogue system 200 to the real-time context, the relationship between the responses and the user's historical and profile context, as well as the level of interest a user shows in the response.

Study results showed that, compared to the baseline method without any personal contexts, the context-aware dialogue system 200 improves the grounding score by 42.26%. Also, the context-aware dialogue system 200 substantially improves the performance by 8.63%, 40.00%, and 29.81% in relevance, personalization, and engagement score, respectively. The in-field pilot study further showed that the grounding score exhibits an increasing trend over time, which indicates that the context-aware dialogue system 200 is capable of improving common ground with users through interactions. Studies have been conducted to also analyze the behavior of the context-aware dialogue system 200 in various applications, such as emotional support, and personal assistance. Semi-structured interviews have been conducted to provide qualitative insights.

In various aspects, the context-aware dialogue system 200 may utilize various technologies that may include large language models, multimodal dialogue systems, personalized dialogue systems, and wearable dialogue systems.

LLMs are pre-trained on large-scale corpora. Models such as GPT-3.5, GPT-4, Vicuna, Llama 2, Qwen, and Falcon, have demonstrated impressive language understanding and modelling capabilities unseen in neural networks of smaller parametric scales. In addition to outstanding language intelligence, LLMs also have surprising and valuable capabilities. These capabilities are sometimes called “emergent capabilities.” One such capability is in-context learning, in which the LLMs need only be exposed to a few examples for its learning to transfer to a new task/domain. Additionally, through supervised instruction fine-tuning and reinforcement learning with human feedback (RLHF), LLMs can follow human instructions. This feature has enabled LLMs to contribute to a variety of tasks such as text summarization and sentiment analysis.

The Chain-of-Thought (CoT) method may be used to guide LLMs to conduct complex reasonings by prompting to generate intermediate steps. Similarly, for the complex reasoning task, works on X-of-Thought (XoT) move away from CoT's sequential, step-by-step thought chain and structure reasoning in a non-linear manner, such as Tree-of-Thoughts (ToT) and Graph-of-Thoughts (GoT). LLM-based agents may also be used. ReAct generates thoughts and actions in an interleaved manner, leading to human-like decisions in interactive environments. In the planning-execution-refinement paradigm, AutoGPT follows an iterative process reminiscent of human-like problem-solving, i.e., a plan is proposed, executed, and then refined based on feedback and outcomes. Systems like Generative Agents and ChatDev explore multi-agent collaboration; agents interact with the environment and exchange information with each other to collaborate and share task-relevant information.

In various aspects, the context-aware dialogue system 200 generally follows the prompt generation paradigms in ICL and CoT. In an example, the context-aware dialogue system 200 may be based on the planning-execution-refinement paradigm. For example, the context-aware dialogue system 200 may investigate the context to generate a plan that is used to select and action. The plan may be iteratively refined based on user feedback when creating a dialogue strategy.

Multimodal dialogue systems leverage contextual information from multiple modalities, such as text and images, to improve users' experience. The visual dialogue may involve, for example, two participants in an image-based question-answering task, where a person asks a question about an image and a chatbot gives a response. An image-grounded conversation (IGC) task may be used to improve the conversation experience by allowing the system to answer and ask questions based on visual content. However, despite progress in extending dialogue context modalities, such systems do not use natural language modelling capabilities.

In some cases, multimodal dialogue systems use the capabilities of both the visual and language models. Such vision-language models (VLMs) may generate coherent language responses consistent with the visual context. However, VLMs still face challenges in generating natural dialogues that occur in real-life interactions. Furthermore, an interactive vision-language task MIMIC-IT may be used to allow dialogue systems to engage in immersive conversations based on the multimodal context.

In various aspects, the context-aware dialogue system 200 may combine the visual understanding capabilities of VLMs with the dialogue capabilities of LLMs to enhance the conversational experience.

User profiles such as personality, preferences, and habits may be extracted from user interactions to support personalized dialogue. However, in some cases, only short-term dialogues are used, not gradually increasing their understanding of users via long-term interactions. A long-term dialogue task including user profiles may also be used. However, this task may not consider the key elements of extracting, updating, and utilizing user profiles. To address this limitation, user personas may be identified from utterances in a conversation. Such user personas may be used to generate role-based responses.

Visual modalities may be incorporated to enhance the understanding of user profiles from recorded episodic memory. Incorporation of visual modalities may overcome the limitation of relying on text-only conversations. However, these episodic memories mainly consist of images and texts shared on social media rather than users' real-life experiences. Combining episodic memory with user profiles, LLMs may be used to summarize conversations into episodic memories and user profiles, which may then be stored in a vector database and retrieved based on the dialogue context in subsequent conversations, resulting in personalized responses.

In various aspects, the context-aware dialogue system 200 generates historical context and user profile from multimodal information captured in real-world scenarios. The context-aware dialogue system 200 may utilize more real-time user information sources as compared to previous dialogue systems. Furthermore, a mechanism for accumulating user information may be used, enabling the system to enhance its knowledge of users over time.

Wearable dialogue systems may combine wearable technology with conversational AI. Wearable dialogue systems may focus on specific user groups or application domains, such as the visually impaired or the healthcare domain. For example, a wearable dialogue system may be used for visually impaired individuals. Such wearable dialogue system may employ smart eyewear with 3D vision, a microphone, and a speaker to facilitate outdoor navigation through conversation. A wearable dialogue system may combine wearable devices and interactive agents to promote and encouraging elderly people to take better care of their health, for example. The approach may involve integrating health data into conversations with users, to make elderly people aware of their health issues and encourage self-care.

A dialogue system based on smart eyewear may interact with users through voice and provide daily life information, such as weather. Additionally, the system may also gather users' biometric data, such as pulse and body temperature, to offer health management guidance through conversation. A mobile dialogue system may be used to collect physical activity data through fitness trackers and guides users to reflect on their daily physical activities through conversations. A mobile health assistant may monitor diet and offers suggestions through conversations. The system may track nutritional information by scanning product barcodes or analyzing food images, offer dietary recommendations, and may utilize the user's global positioning system (GPS) location to recommend nearby restaurants.

In various aspects, the context-aware dialogue system 200 may offer personalized conversations and companionship to the user. By combining wearable technology with advanced conversational AI, the context-aware dialogue system 200 may provide a seamless and natural interaction experience that provides functional support, such as providing advice on carrying out specific tasks, and also goes beyond such functional support. The context-aware dialogue system 200 may incorporate contextual information to continually improve the quality of the interaction and adapt to the user's experiences and preferences over time, thereby creating a sustainable personal companion for the user.

In various aspects, design of the disclosed context-aware dialogue system may consider the following five aspects of requirements: 1) episodic understanding, 2) memorization ability, 3) personalization awareness, 4) personalized responsiveness, and 5) ubiquitous accessibility.

To achieve episodic understanding, the context-aware dialogue system 200 may perceive the user's ongoing conversation and understand the in-situ context in real-time, including the visual and auditory surroundings, location, and activity. Therefore, the disclosed smart eyewear-based system may be equipped with cameras, microphones, and speakers to capture the surrounding images and speech. The surrounding images and speech may be converted into text using a vision-language model, such as LLaVA, and a speech recognition model, such as Whisper. The converted texts from the images and speech may then be fused to form a prompt. The context-aware dialogue system 200 may utilize responses of a large language model, such as a generative pre-trained transformer (GPT) or another suitable large language model, to infer the user's real-time context via the prompt.

To enable memorization, the context-aware dialogue system 200 may generate, store, and recall the historical contexts, including the user's past daily events and dialogue content. To reduce redundant storage of past real-time contexts and achieve effective retrieval, the context-aware dialogue system 200 may summarize the past real-time contexts via a clustering approach that considers semantic similarity. In some examples, highly similar real-time contexts may be clustered and summarized into distinct events using a large language model, such as a GPT model or another suitable large language model, thus serving as historical contexts. Additionally, a mechanism may be used to generate the temporal, spatial, and semantic indices for the historical contexts, which may be stored in a vector database, such as Milvus, enabling retrieval of similar historical contexts in these three dimensions.

In an aspect, the context-aware dialogue system 200 may distill and update user profiles over time based on inference of the user's personality, preferences, social background, and life habits from the historical contexts via a large language model, such as a GPT model or another suitable large language model. Such user profile distillation and update may further enhance the personalization of the context-aware dialogue system 200. The updating mechanism may assign a confidence score to each user profile to guide the review and revision of existing profiles. When a new user profile is generated, the context-aware dialogue system 200 may retrieve the most semantically similar existing profile from the database (e.g., Milvus). The new and existing profiles may be merged to construct a prompt for the large language model, which generates an updated user profile and is then stored in the database (e.g., Milvus).

In an aspect, the context-aware dialogue system 200 may generate personalized responses using LLM-based agents, including a dialogue strategy agent and an information retrieval agent. The dialogue strategy agent may decide the conversational strategy, while the information retrieval agent may retrieve relevant information from historical contexts and user profiles following the planned strategy. The personal context, including the retrieved information and real-time context along with the dialogue strategy, may be used to construct a prompt for a large language model, such as a GPT model or another suitable large language model, to generate personalized responses.

In an aspect, the context-aware dialogue system 200 may be configured to provide ubiquitous accessibility. To enable conversation anytime and anywhere, a lightweight, portable, battery-powered hardware device may be used. The hardware device may have constraints on computing ability and battery capacity. Aspects of the present provide a system with the episodic understanding, memorization ability, personalization awareness, and personalized responsiveness capabilities in the presence of these constraints. In an aspect, architecture of the context-aware dialogue system 200 may perform basic functions, including image capture, audio recording, and audio playback, locally on the smart eyewear device while offloading more compute-and energy-intensive functions, including real-time context capture, historical context extraction, user profile distillation, and personalized response generation to the cloud.

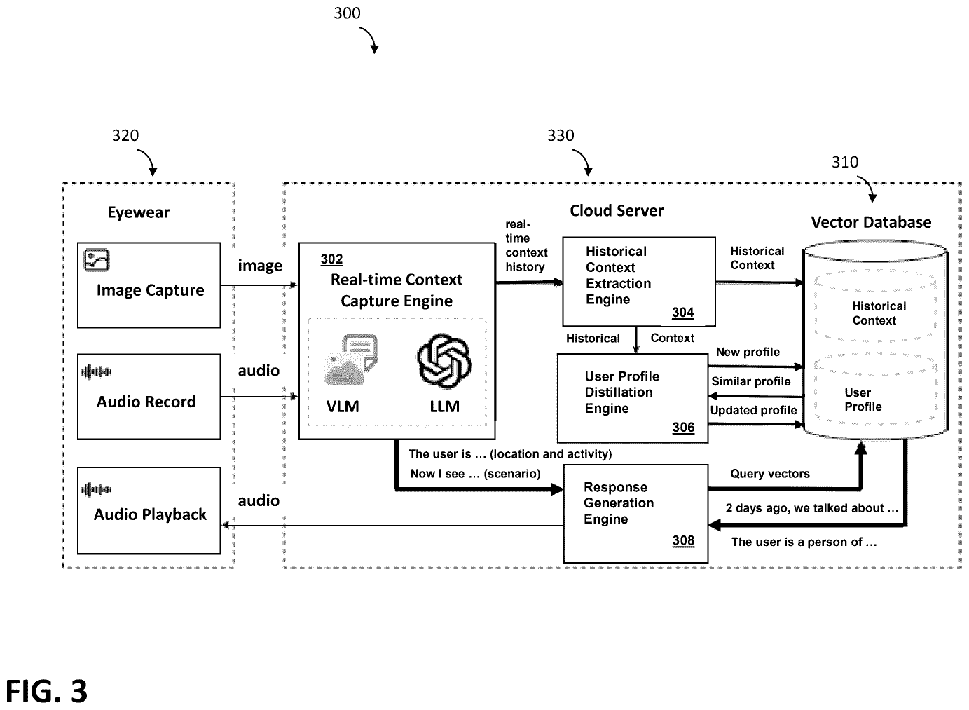

Referring now to FIG. 3, a diagram depicting an implementation of a personalized dialogue system 300, in accordance with one example, is provided. The personalized dialogue system 300 may include an eyewear device 320 and a context-aware dialogue system 330. In some examples, the context-aware dialogue system 330 corresponds to the context-aware dialogue system 200 of FIG. 2. The context-aware dialogue system 330 includes an real-time context capture engine 302 (e.g., corresponding to the real-time context capture engine 202 of FIG. 2), a historical context extraction engine 304 (e.g., corresponding to the historical context extraction engine 204 of FIG. 2), a user profile distillation engine 306 (e.g., corresponding to the user profile distillation engine 306 of FIG. 2), and a personalized response generation engine 308 (e.g., corresponding to the personalized response generation engine 208 of FIG. 2). The context-aware dialogue system 330 may also include or be coupled to a database 310 (e.g., corresponding to the database 210 of FIG. 2). In an example, the database 310 may be a vector database. In another example, the database 310 may be a suitable type of database other than a vector database.

In various aspects, one or more data modalities descriptive or an environment of a user, such as image and audio data captured by the eyewear device 320, may be sent to a cloud server for processing by the context-aware dialogue system 330. As explained in more detail below, processing may be performed with four sequential steps. When a user begins a conversation, the context-aware dialogue system 330 may generate a response that may be converted to audio and played out to the user via the eyewear device 320. In operation, in the real-time context capture stage, the eyewear device 320 may obtain the surrounding image and audio, and may transmit the image and audio data to the context-aware dialogue engine 330, which may be implemented at least partially in the cloud, for real-time context capture. The real-time context capture engine 302 may generate an real-time context 352 based on the received image and audio data. In the historical context extraction stage, the historical context extraction engine 304 may extract the daily events and conversation summaries from the history of real-time contexts. The daily events and conversation summaries may be assigned multi-dimensional indices and an importance score, and then stored in the database 310 as historical context. In the user profile distillation stage, the user profile distillation engine 306 may generate a new user profile from historical contexts and retrieves a similar user profile from the vector database. The new user profile and the similar user profile may be merged to obtain an updated user profile, which may then be stored in the database 310.

In the personalized response generation stage, the personalized response generation engine 308 may generate multi-dimensional query vectors based on the current episodic context, and may use the multi-dimensional query vectors to retrieve similar historical contexts and user profiles from the database 310. In an example, the personalized response generation engine 308 may use a dialogue strategy agent and an information retrieval agent. The dialogue strategy agent may plan the conversational strategy, while the information retrieval agent may retrieve the relevant information from historical contexts and user profiles. The personalized response generation engine 308 may combine the real-time context and the retrieved information with the dialogue strategy to generate text responses using a suitable large language model. Subsequently, these responses are converted to speech and played back on the eyewear. In an example, both two different LLMS may be used. For example, a relatively larger and more accurate LLM model (e.g., a relatively larger GPT model) may be used to generate the final response for its superior quality and a relatively smaller less accurate LLM model (e.g., a relatively smaller GPT model) may be used for other tasks to control the overall cost of the disclosed system. The relatively smaller LLM model is sometimes referred to herein as LLM-Base, while the relatively larger LLM model is sometimes referred to herein as LLM-Large. Generally, the LLM-Large model may be more complex and may provide better quality as compared to the LLM-Base model. On the other hand, the LLM-Base model may be less complex and may be cheaper in terms of power consumption, cost, etc. as compared to the LLM-Large model.

In an aspect, the eyewear device 320 may capture real-time visual and audio signals through built-in camera and microphone on the smart glasses. The eyewear device 320 may provide the captured real-time visual and audio signals to the context-aware dialogue engine 330, which may be implemented at least partially in the cloud. The context-aware dialogue engine 330 may use a vision-language model to convert visual signals into descriptions, providing textual descriptions of scenes, such as “a desk with a laptop”. Additionally, the context-aware dialogue engine 330 may use an audio speech recognition model to transcribe audio signals into text, recognizing what the user said, such as “I am so busy”. By semantically combining the textual descriptions from visual and audio signals, the context-aware dialogue engine 330 may leverage the knowledge of LLM-Base to infer the user's location and activity. For example, the context-aware dialogue engine 330 may determine that the user is in the “office” and the user's activity is “working”. The texts obtained from the image and audio signals and the location and activity inferred by LLM-Base form the real-time context may enable the context-aware dialogue engine 330 to understand the user's current situation.

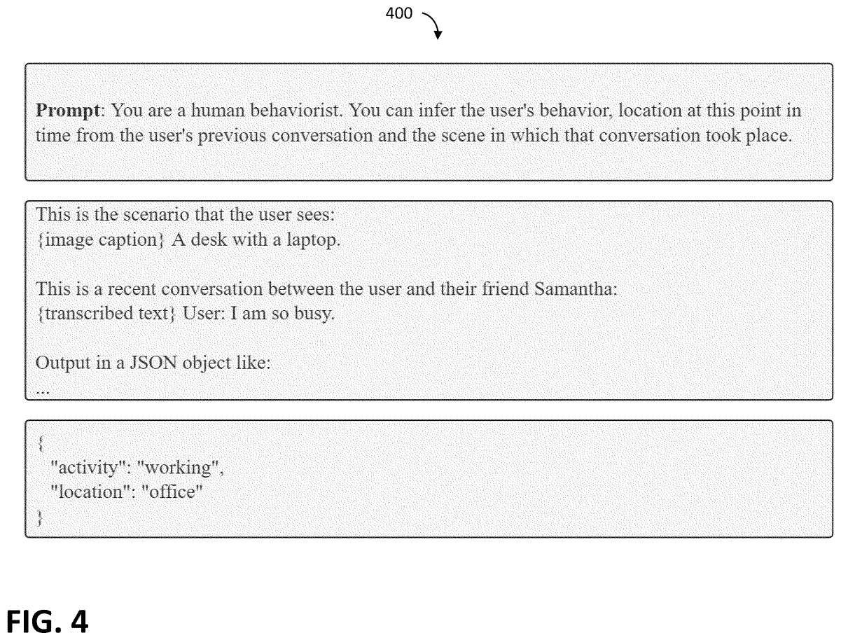

In an example, during a conversation between the user and the personalized dialogue system 300, the audio signal corresponding to the t-th utterance of the user is denoted as A^{t}, and the most recently captured image signal is denoted as l^{t}, are provided to the real-time context capture engine 302. The real-time context capture engine 302 may employ a speech recognition model Nasr to transcribe A^{t} into text, resulting in u^{t}=Nₐₛᵣ(A^{t}), where u^{t} represents the transcribed text of the t-th utterance A^{t} of the user. For the image signal, the real-time context capture engine 302 may employ a vision-language model Nylm to generate a textual description of the scene, resulting in v^{t}=Nulm (It), where u^{t} represents the caption of the image signal l^{t}. The real-time context capture engine 302 may also construct a prompt for LLM-Base, and may use the prompt to infer the current location and activity, {l^{t}, a^{t}}=Nₗₗₘ(v^{t}, u^{t}), where Nₗₗₘ is LLM-Base, l^{t} represents the location, and a^{t} represents the activity. FIG. 4 illustrates an example process 400 that may be implemented by the real-time context capture engine 302 to infer activity and location, according to an example. Referring again to FIG. 3, the real-time context capture engine 302 may thus obtain the real-time context for the t-th utterance, denoted as Cₑ^{t}={v^{t}, u^{t}, l^{t}, a^{t}}.

The historical context extraction engine 304 may generate a historical context for the user based on real-time contexts obtained for the user over time. As time goes by, the context-aware dialogue engine 330 may accumulate an increasing number of real-time contexts, some of which will be largely redundant. For example, for a user who spends a long time working on a computer, the real-time context about location and activity collected by the context-aware dialogue engine 330 would become repetitive. In an aspect, the historical context extraction engine 304 may remove uninformative redundancy from stored contexts. The historical context extracted by the historical context extraction engine 304 may fall into two classes: daily events and conversation summaries. Daily events may be represented as triplets consisting of time, location, and activity. Such daily events may allow historical context extraction engine 304 to store historical schedules, e.g., “<2023 Nov. 1 16:00:00-2023 Nov. 1 17:00:00, at the gym, playing badminton>”. The conversation summary may include the topics and details of past conversations, such as “the user mentions writing a paper and asks for tips on how to write it well”.

In an aspect, the historical context extraction engine 304 may implement an event clustering method that groups sequences of events into appropriate clusters and summarizes them in event-level text descriptions. To extract conversation summaries, the conversation history may be divided into sessions based on contiguous time intervals. For each session, the historical context extraction engine 304 may construct a prompt and use the summarization capability of LLM-Base to extract a summary of the prompt. Furthermore, to enhance the storage and retrieval of historical contexts in the vector database, the historical context extraction engine 304 may use an indexing mechanism that organizes the historical context into temporal, spatial, and semantic dimensions, following the format humans typically use to describe historical contexts. Additionally, the indexing mechanism may assign different importance scores to the historical contexts based on emotional arousal levels. The historical context with a higher arousal level may be considered more important and may more likely be referenced in subsequent conversations, as users are more likely to remember events with stronger emotional impact. The event clustering, conversation summary, and indexing mechanism, according to examples, are described in more detail below.

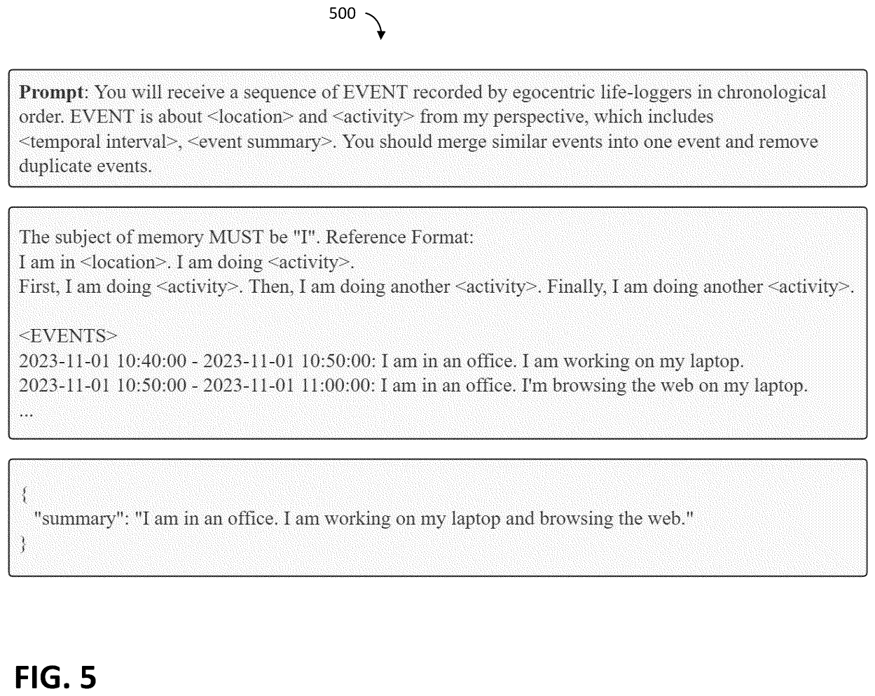

The historical context extraction engine 304 may implement clustering to cluster similar events. Such clustering may be performed, for example, using a vector clustering technique. In other examples, other suitable clustering mechanisms may be used to cluster similar events. In an example, during a day, the personalized dialogue system 300 captures a sequence of m real-time contexts. For each real-time context, the historical context extraction engine 304 may use an embedding model N_{embed} to generate a representation vector e^{t}, denoted as e^{t}=N_{embed} ({l^{t}, a^{t}}), where {l^{t}, a^{t}} represents concatenated text descriptions of location and activity. These embedded vectors form an embedding matrix Mₑ, with each vector being a row in the matrix. Subsequently, the historical context extraction engine 304 may calculate the cosine similarity between the representation vectors of each pair of real-time contexts in the sequence to generate the similarity matrix Mₛ=MₑMₑ^{T}. The historical context extraction engine 304 may then set a similarity threshold, which may be used to group together real-time contexts that have a cosine similarity above the threshold into an event. Due to the spatiotemporal locality of events, semantically similar real-time contexts are usually contiguous subsequences. Therefore, by sequentially traversing the overall real-time context sequence and comparing similarity with the threshold, the longest contiguous subsequence that satisfies all the following conditions is selected to cluster an event: 1) the similarity between the first element of the subsequence and the previous subsequence is below the threshold, 2) the similarities among all elements within the subsequence are above the threshold, and 3) the similarity between the last element of the subsequence and the subsequent subsequence is below the threshold. The historical context extraction engine 304 may create a prompt that summarizes a collection of real-time contexts that have been grouped together into an event. FIG. 5 illustrates an example process 500 that may be implemented by the historical context extraction engine 304 to generate an event summary, according to an example. Referring again to FIG. 3, the historical context extraction engine 304 may employ the corresponding real-time contexts for each longest subsequence as parts of the prompt for LLM-Base. Finally, the historical context extraction engine 304 may extract a summary of the event, denoted as {E¹, . . . , E^{P}}=f_{cluster}({e¹, . . . , e^{m}}), where Eⁱ represents a daily event, m represents the number of original unclustered real-time contexts, and p represents the number of distinct events without redundancy after clustering.

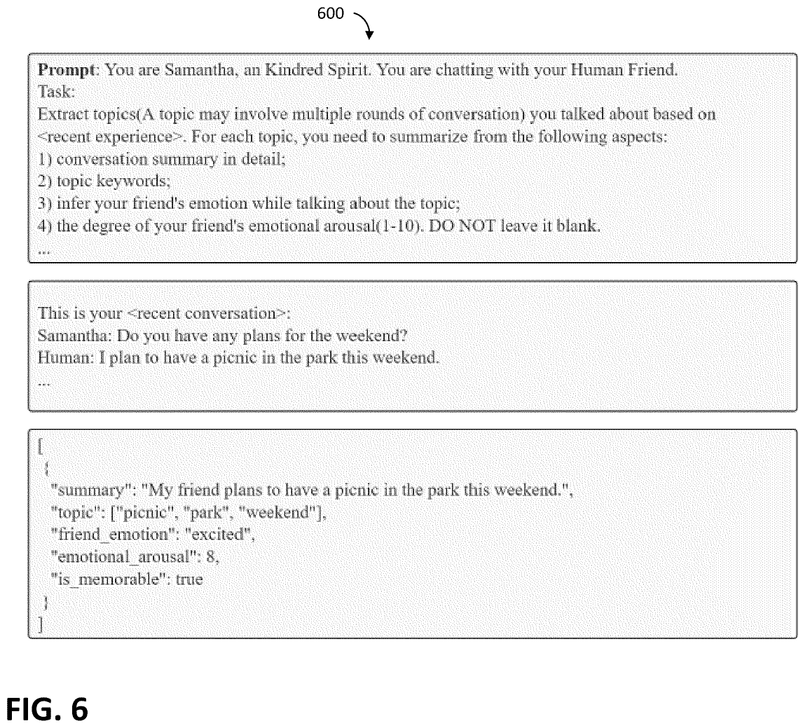

To extract conversation summaries from the conversation history, the historical context extraction engine 304 may use an interval threshold that determines the maximum allowed time interval within a conversation. The threshold may serve as a boundary to separate conversations that exceed the interval threshold into different sessions, denoted as {D¹, . . . , D^{q}}=fₛₑₛₛᵢₒₙ({u¹, b¹, . . . , uⁿ, bⁿ}), where D^{j} refers to a session, uⁱ represents the user's utterance, and b¹ represents the response generated by the context-aware dialogue engine 330. After partitioning the conversation history, the historical context extraction engine 304 may construct a prompt for each session to summarize topics and details by leveraging the summarization capability of LLM-Base. FIG. 6 illustrates an example process 600 that may be implemented by the historical context extraction engine 304 to generate a conversation summary, according to an example. Referring again to FIG. 3, the summaries obtained by the historical context extraction engine 304 may be denoted as {T¹, . . . , T^{q}}=Nₗₗₘ({D¹, . . . , D^{q}}), where T^{j} represents a conversation summary. The collections of daily event Eⁱ and conversation summary T^{j} together may form the historical context that may be formally represented as: Cₕ^{1:p+q}={E¹, . . . , Eⁱ, . . . , E^{P}, T¹, . . . , T^{j}, . . . , T^{q}}.

The historical context extraction engine 304 may implement an indexing mechanism that organizes historical context in three dimensions: temporal, spatial, and semantic. The indexing mechanism may be used to generate a list of indexing keys for textual descriptions of historical context, including daily events and conversation summaries. For example, if the historical context is “I plan to have a picnic in the park this weekend”, the resulting indexing keys could include “weekend plan”, “in the park”, and “have a picnic”. By allowing multiple indexing keys to be associated with each historical context, the historical context extraction engine 304 may perform associative retrieval in different dimensions. For example, the historical context extraction engine 304 may generate a prompt for LLM-Base to extract the textual descriptions related to the temporal, spatial, and semantic aspects of the historical context. These extracted descriptions may serve as indexing keys for the historical context. The process of generating indexing keys Kⁱ is denoted as f_{index}.

In some aspects, the historical context extraction engine 304 may incorporate emotional factors in historical context indexing. To achieve this, the historical context extraction engine 304 may generate a prompt and leverage LLM-Base to evaluate the level of emotional arousal associated with a given historical context. This level may determine the significance of the historical context, which may be represented by an importance score ranging from 1 to 10, for example. The historical context extraction engine 304 may assign higher importance scores to historical contexts with intensified emotional arousal, thereby increasing the likelihood of mentioning them in the conversation. The process of assigning importance scores sⁱ is denoted as f_{score}.

In an example, the indexing mechanism for historical context, that may be implemented by the historical context extraction engine 304, may be formally described as follows:
1) generate indexing keys from multiple dimensions for each historical context, denoted as Kⁱ=f_{index}(Cₕⁱ),
2) assign an importance score to each historical context, denoted as Sⁱ=f_{score}(Cₕⁱ), and
3) store the historical context in the vector database, along with the corresponding indexing keys and importance score.

The user profile distillation engine 306 may distill a user profile from the historical context generated for the user. Historical context represents the user's daily events and conversation summaries. It can therefore provide important clues about the user profile, including personality, preferences, social background, and life habits. By summarizing patterns from the historical context, the user profile distillation engine 306 may distill the user profile and thereby improve the personalized user experience. For example, if a user frequently eats spicy food, it becomes evident that the user has a preference for spicy food. The user profile may consist of a textual description of a specific aspect of the user, along with a confidence score that indicates the reliability of the information. In an aspect, the user profile distillation engine 306 may generate an additional confidence score because user profile distillation is an ongoing process that aims to tackle biases and errors when inferring user profiles.

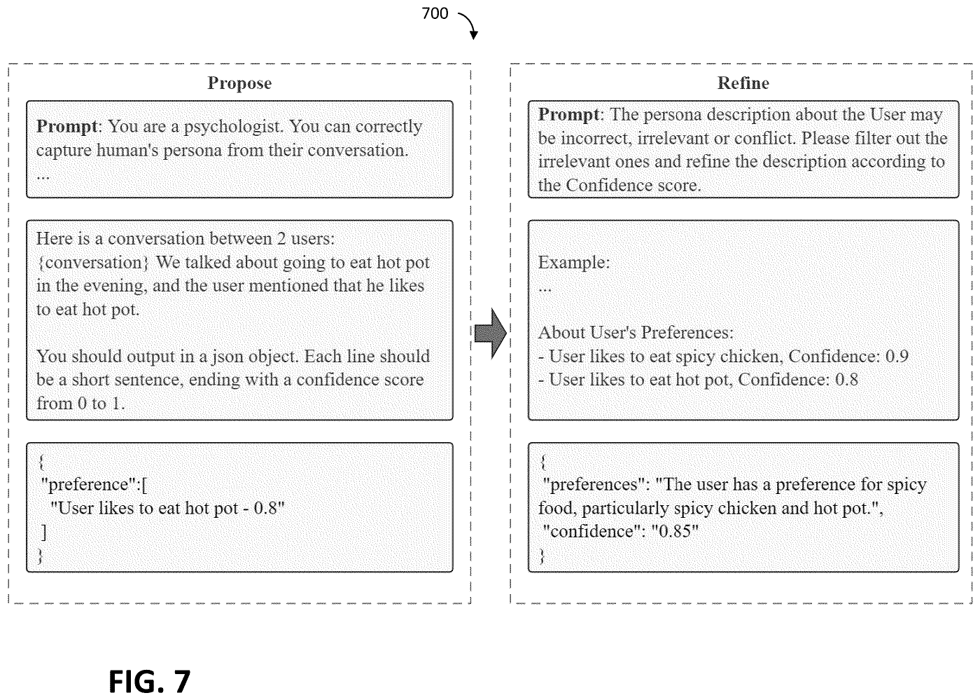

FIG. 7 illustrates an example process 700 that may be implemented by the user profile distillation engine 306 to generate a user profile, according to an example. The distillation process may be divided into the following steps. First, the user profile distillation engine 306 may generate a prompt for LLM-Base to summarize a historical context into a proposal of user profile, denoted Cᵤⁱ=Nₗₗₘ(Cₕⁱ). Second, the user profile distillation engine 306 may use an embedding model to encode Cᵤⁱ, resulting in a query vector. The user profile distillation engine 306 may use the query vector to retrieve, from the database 310, the user profile with the highest cosine similarity and more than the similarity threshold, denoted as Cᵤ^{i′}=fᵣₑₜᵣᵢₑᵥₑ(Cᵤⁱ), where ci′ represents the existing user profile. If no user profile exceeds the similarity threshold, the user profile proposal is stored in the database 310. Otherwise, the user profile distillation engine 306 may generate a prompt for LLM-Base to revise the concatenation of the existing user profile and the user profile proposal, denoted as Cᵤ^{i′}=Nₗₗₘ(Cᵤⁱ, Cᵤ^{i′}), where Cᵤ^{i′} represents the updated user profile. Finally, the user profile distillation engine 306 replaces Cᵤ^{i′} with Cᵤ^{i′} in the database 310. The updating mechanism may enable the user profile distillation engine 306 to rectify inaccurate user profiles and reinforce correct user profiles over time.

The personalized response generation engine 308 may generate responses to be provided to the user. In an aspect, to enhance user engagement, the personalized response generation engine 308 may utilize agents-a dialogue strategy agent and an information retrieval agent—to assist in generating personalized responses. The dialogue strategy agent may be responsible for planning the direction of the conversation based on real-time context and guiding users to express their opinions by asking questions, or provide additional information to drive the conversation forward. Subsequently, the information retrieval agent may determine which user information to retrieve based on the dialogue strategy suggested by the dialogue strategy agent and summarizes the retrieved user information. The information retrieval agent may leverage real-time context to retrieve relevant information from historical contexts and user profiles, such as experiences and preferences. The personalized response generation engine 308 may combine the real-time context and the information retrieved by the information retrieval agent as personal context, along with the dialogue strategy planned by the dialogue strategy agent, to serve as prompts for LLM-Large to generate text responses. The generated reply may then be converted into speech using a text-to-speech service, for example, and may be transmitted to the smart eyewear device 320 for playback to the user.

In an example, the dialogue strategy agent may include two engines: a planner engine and a decider engine. The planner engine may produce a dialogue strategy plan. The decider engine may determine the specific strategy action to be taken.

The reasoning process of the planner engine may include three steps:
1) Defining objective: The planner engine may define the objective of the dialogue based on the given context, e.g., provide emotional support to the user.
2) Proposing strategy: The planner engine may generate a strategy plan based on the defined dialogue objective. The strategy plan can include multiple steps, such as affirming the user's negative emotions, exploring the causes of the negative emotions, and guiding the user to resolve them.
3) Refining strategy: The planner engine may refine the strategy plan as the dialogue progresses based on the user's feedback. For example, when the strategy from the previous step is to help the user solve a problem, but the user says, “I don't want to think about how to solve the problem right now, can you just comfort me?”, the dialogue strategy may be adjusted from problem-solving to providing comfort.

The reasoning process of the decider engine may also include three steps:
1) Analyzing progress: The decider engine may analyze the strategy actions taken thus far in the plan. For example, the decider engine may compare the strategies adopted in the conversation with the pre-determined strategy plan to determine which steps of the plan have already been executed.
2) Evaluating outcomes: The decider engine may analyze the user's feedback from the conversation to evaluate the effectiveness of the strategies employed; for example, whether the user's negative emotions have been mitigated.
3) Making action decisions: The decider engine may decide the next strategy action to be taken based on the analysis and evaluation from the previous steps. If the user's negative emotions haven't been mitigated, the decider engine may continue to address the emotional distress. If the user's negative emotions have been mitigated, the decider engine may start guiding the user toward resolving the root problem.

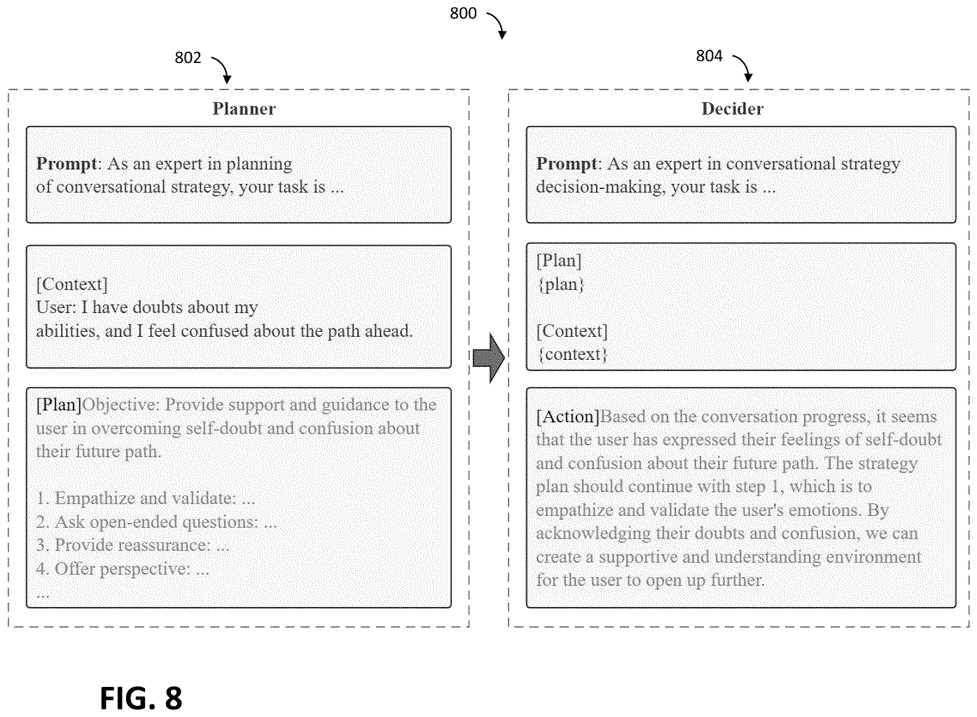

FIG. 8 illustrates operation of a dialogue strategy agent 800, including operations of a planner engine 802 and a decider engine 804, according to an example. The planner engine 802 and the decider engine 804 may each consist of a prompt that describes the task and provides guidance for the reasoning process. The prompt may be used as the system prompt for LLM-Base to execute the module's functionality. In an example, during conversation, the planner engine 802 generates a multi-step dialogue strategy plan based on the context of the conversation. Subsequently, the decider engine 804 determines the specific plan action to take. The generated text of the strategy action may then serve as a prompt for guiding LLM-Large to generate a reply that aligns with the specified direction of the strategy.

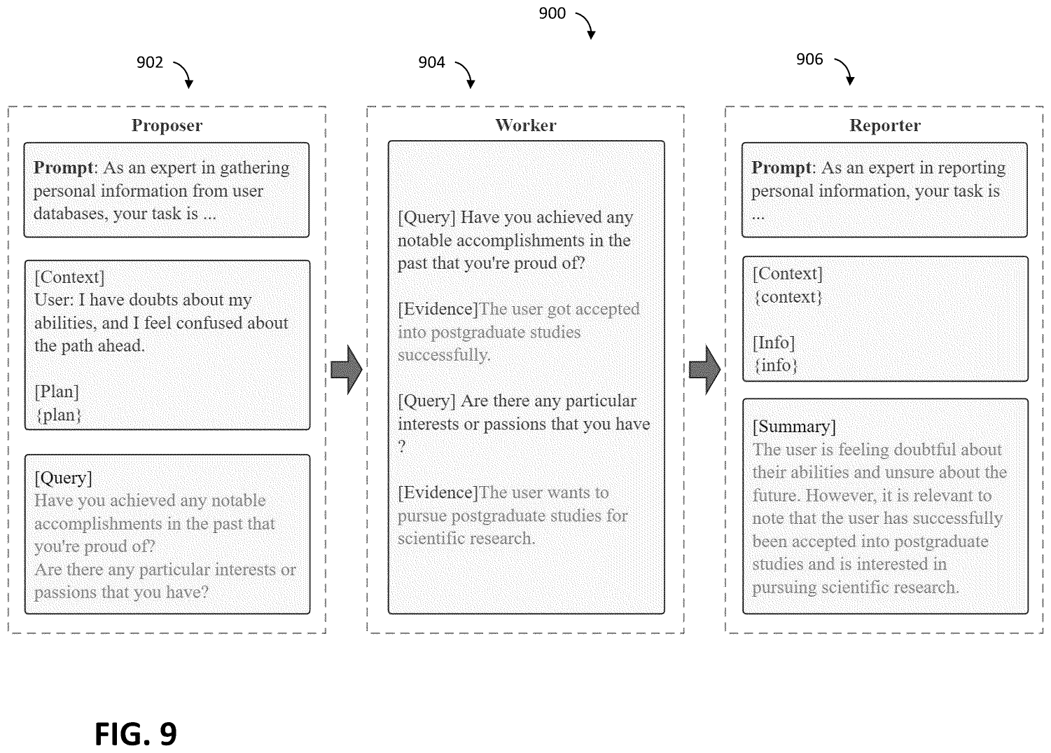

The information retrieval agent may include three engines: a proposer engine, a worker engine, and a reporter engine. The proposer and reporter engines utilize prompts for LLM-Base to generate queries and summarize query results, while the worker engine executes query operations on the vector database. FIG. 9 illustrates operation of an information retrieval agent 900, including operations of a proposer engine 902, a worker engine 904, and a reporter engine 906, according to an example.

In an example, the proposer engine 902 may be responsible for suggesting which aspects of user information should be retrieved based on the real-time context and strategy plan. For example, the proposer engine 902 may propose a list of queries for retrieving historical contexts and user profiles. Each query may describe a specific aspect of the user, such as past achievements, for example.

The worker engine 904 may be responsible for executing the query on the vector database and retrieving the corresponding information. Referring to FIG. 3, during retrieval, the personalized response generation engine 308 may determine the cosine similarity between the query vector and the vectors of historical context and user profile documents. Once retrieval produces a set of candidate documents, the personalized response generation engine 308 may calculate a rank score for each document and may sort the documents to enable selection of the k documents with the highest rank scores. Rank score calculation may be similar to that used in a generative agent: Sᵣₐₙₖ=S_{similarity}+S_{importance}+S_{recency}, where S_{recency} accounts for the recency of the update time of document creation (the more recent the document, the higher the recency score).

The reporter engine 906 may be responsible for extracting and summarizing relevant information from retrieved documents. Additionally, the reporter engine may create a description of user information that serves as a prompt for LLM-Large to generate a response.

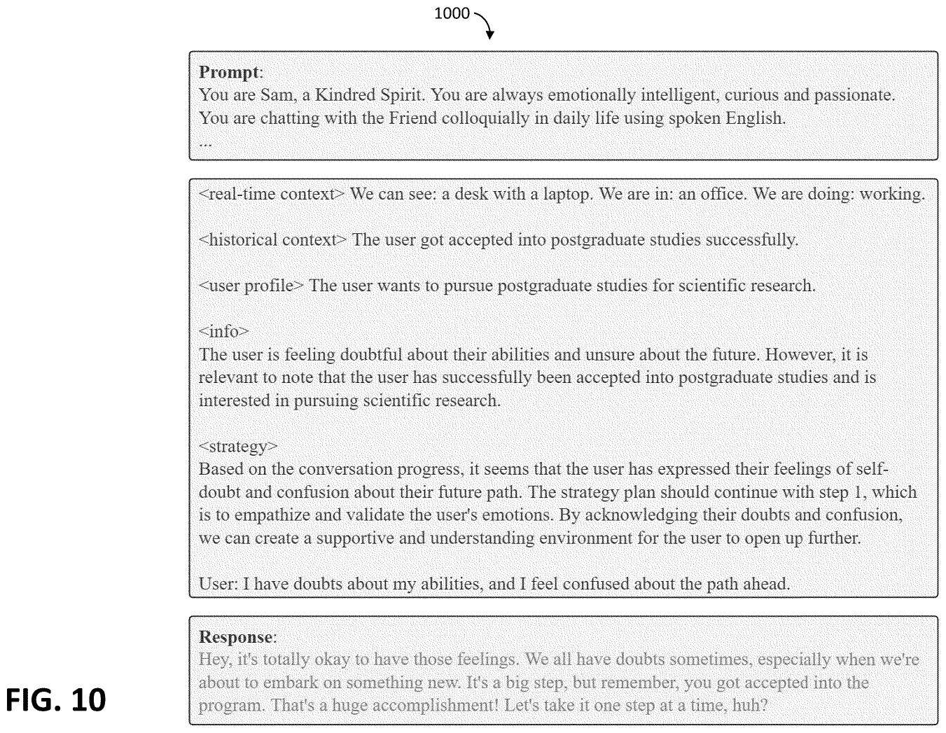

FIG. 10 illustrates operation of a personalized response generation engine 1000 (e.g., corresponding to the personalized response generation engine 308 of FIG. 3), according to an example. The personalized response generation engine 1000 may combine the real-time context, the relevant historical contexts, and the user profiles retrieved by the information retrieval agent to produce the personal context. The personal context and the dialogue strategy planned by the dialogue strategy agent may be used as prompts for LLM-Large to generate personalized responses.

FIG. 11 illustrates an example smart eyewear device 1100 (also sometimes referred to herein as smart glasses) that may be used with a personalized dialogue system, according to an aspect of the present disclosure. In the smart eyewear device 1100, computing components/platform 1102 (e.g., one or more processors) and a power source 1104 (e.g., battery) may be seamlessly integrated into a glasses frame.

In an example, the Snapdragon Wear 4100+ may be used as the computing platform that may be directly integrated into the left arm of the smart glasses. This platform's processing speed may be adequate for real-time data processing and execution of sophisticated algorithms, such as eye tracking and scene capturing.

The eyewear hardware may be equipped with two sensors (e.g., cameras or camera modules) 1106: an inward-facing sensor that faces the eyes of the user and a forward-facing sensor that faces forward with respect to field of view of the user. The inward-facing sensor and/or the forward-facing sensor may comprise a single sensor or may comprise multiple sensors, such as multiple sensors of different types. The inward-facing sensor may be configured to capture information indicative of movement, gaze direction and expression of one or both eyes of the user and/or facial appearance of the user. In various examples, the inward-facing sensor may comprise one or more of i) a camera, such as a visible light camera, an infrared camera, etc. that may be configured to capture images or videos depicting one or both eyes of the user, ii) an infrared sensor configured to capture eye movement, eye gaze direction and/or eye or facial expression information based on active IR illumination of one or both eyes of the user, iii) a camera configured to passively capture appearance of or one or both eyes of the user, etc. In some examples, the inward-facing sensor may comprise one or more wearable position and/or orientation sensor devices, such as an accelerometer, a gyroscope, a magnetometer, etc., that may be attached to the user (e.g., user's head, user's body, etc.), or to a wearable device (e.g., eyewear) that may be worn by the user, and may be configured to detect position and/or orientation of the user (e.g., user's head and/or body) relative to the scene being viewed by the user. In an example, the orientation and/or position of the user relative to the scene being viewed by the user may be indicative of the eye movement and/or gaze direction of the user relative to the scene. In other examples, the inward-facing sensor may additionally or alternatively comprise other suitable sensor devices that may be configured to capture or otherwise generate information indicative of eye movement, eye gaze direction and/or eye or facial expression of the user.

The forward-facing sensor may be a visual scene sensor that may be configured to capture image data, video data, etc. capturing the scene in the field of view of the user. In various examples, the forward-facing sensor may comprise one or more of i) a camera, such as a visible light camera, an infrared camera, etc., ii) a camcorder, iii) a video recorder, etc. In other examples, the forward-facing sensor may additionally or alternatively comprise other suitable sensor devices that may be configured to capture or otherwise generate data, such as image or video data, indicative of visual content in the field of view of the user.

In an example, the inward-facing sensor and the forward-facing sensor are mounted on the smart eyewear device that may be worn by the user. The inward-facing sensor and the forward-facing sensor may thus readily enable ubiquitous gathering of eye and scene information during daily activities of the user. In other examples, instead of being attached to a user or to a device worn by the user, the inward-facing sensor and/or the forward-facing sensor may be located at a suitable distance from the user. For example, the inward-facing sensor and/or the forward-facing sensor may be a distance sensor (e.g., distance camera) positioned in the vicinity of the user. As just an example, the inward-facing sensor may be a web camera, or webcam, that may generally be facing the user as the user is viewing the scene.

In an example, the forward-facing sensor may comprise an 8-megapixel (MP) scene camera and the inward-facing sensor may comprise a 5-megapixel (MP) eye camera. In other examples, other suitable types of sensors may be used. The forward-facing scene camera may capture the surrounding scene images, providing visual context to the system. The inward-facing eye camera may record eye videos, supporting eye tracking.

In the example illustrated in FIG. 11, the eyewear frame design houses the sensors 1106 within its left arm. The sensors may be unobtrusive and aligned with the user's field of view. To provide a well-balanced and comfortable fit, the battery 1104 may be integrated into the right arm of the glasses, thereby balancing the frame.

In addition to the body of the eyewear, a monaural Bluetooth earphone may be used to record audio of the user and environment. A speaker may be used to produce verbal responses.

The eyewear system (e.g., implemented in software) may operate on a suitable operation system, such as Android 8.1, providing a platform for communication between the user and the cloud services. Initially, the user may be required to configure a WiFi connection to access the cloud and enable uninterrupted communication. In an aspect, the software has four functions: capturing audio, scene images, eye orientations, and playing the audio output of responses received from the cloud server.

Audio: The eyewear system may continuously capture audio from the user's surroundings, which is streamed to the cloud in real-time. In the cloud, a voice recognition system processes the audio stream, converting it into text.

Image: The eyewear system may periodically capture 640×480 scene images at specific time intervals (every 10 seconds in this work). To optimize data transmission, the captured images may undergo compression (e.g., JPEG compression) before being uploaded to the cloud. Once uploaded, the cloud (e.g., a server on the cloud) may perform feature extraction on the images, allowing insight into the user's current environment.

Eye-tracking: An eye-tracking algorithm (e.g., Pupil Invisible or a similar eye-tracking algorithm) may run on the eyewear system. The algorithm may provide the position of the user's gaze on scene images.

Playback: The eyewear system may play the human-like audio response generated from the cloud.

The cloud services may consist of five components, each capable of handling multiple processes concurrently to support simultaneous interactions with multiple users. Redis queues may be used for communication among these services. In other examples, other suitable types of communication among the services may be used.

Data Server: The data server may be responsible for facilitating communication with the eyewear. In an aspect, the data server is built on the FastAPI framework and has two key interfaces. The first interface allows uploading data, including timestamps, audio, images, and other relevant information. Upon receipt, these data are placed in the appropriate queue, awaiting processing. The second interface returns generated audio replies. The second interface may retrieve audio from the response queue, and may stream the audio to the user's eyewear through the Starlette framework, for example.

Image Server: The image server component may retrieve images from the queue, and may process the images using the LLaVA model for content recognition. In an example, the LLaVA-7B-v0 model is employed, with parameter settings as follows: max_new_tokens=512 and temperature=0.

Audio Server: For each online user, a dedicated thread may be created to handle the audio input. This thread may continuously receive audio data from the users' eyewear system, and may use Whisper for speech recognition. In other examples, other suitable speech recognition systems may be used.

Chatbot Server: The chatbot server may serve as the core service within the cloud, generating responses based on the user's surrounding environment and conversation content. In aspects, the responses include textual content, as described above.

TTS Server: The TTS server may convert textual responses into the audio format. This component may use a commercial text-to-speech service for efficient and high-quality audio synthesis.

In an example, the processing time for the cloud services is approximately 1.82 seconds, which is at the most common pause time in human conversation (1-3 seconds), allowing for natural communication with the context-aware dialogue system.

The performance of an example context-aware dialogue system (OS-1) empowered by effective personal context capturing has been evaluated. The example context-aware dialogue system (OS-1) is designed to cater to diverse users with varying profiles who engage in various conversation scenarios during their daily lives. To this end, a variety of conversation situations and simulated users with various profiles in a controlled laboratory setting have been considered. Volunteers were recruited to participate in pilot studies for approximately 14 days to examine the long-term effectiveness when OS-1 is used in real-world scenarios.

For the in-lab experiments, the experimental settings to simulate various daily-life scenarios and users with diverse social backgrounds and personalities is outlined below. Further, comparisons between the performance of OS-1 with the performance of several baseline methods are provided below. The baseline methods operate without considering personal context. A case study was also performed to further explain why OS-1 outperforms the baseline methods.

User simulation was performed. To verify the ability of OS-1 to adapt to diverse users, GPT-4 was adapted to simulate virtual users with varying personalities, social backgrounds, and experiences. In particular, 20 distinct virtual users were created, consisting of 10 males and 10 females ranging in age from 15 to 60. Each virtual user was assigned a name randomly selected from the U.S. 2010 Census Data. Also, each user was assigned a personality based on the Myers-Briggs Type Indicator (MBTI). To make the virtual users more realistic, each virtual user was provided with an occupation, preferences, and habits, along with daily routines tailored to their individual characteristics.

Visual scene simulation was also performed. GPT-3.5 was used to directly simulate the daily visual scenes of the 20 users at a given moment. The represent the visual surroundings perceived by users. The visual scenes may be represented as a four-tuple, including time, location, action, and a brief text description of what the user perceives. For example, a college student, Benally majoring in Chemistry, might experience a visual scene of <2023 Oct. 2 Monday 9:00-12:00, Chemistry Lab, Attending lectures and practicals, “A table filled with beakers and test tubes.”>.

In total, 80 daily visual scenes were simulated for each user, with 8 scenes per day and a duration of 10 days.

Dialogue simulation was also performed. Three daily visual scenes were randomly selected for each user. The user was asked to initiate a conversation with OS-1 based on the visual scene. Each conversation consisted of three rounds. This way, each user's personal context, consisting of the simulated speech and their daily visual surroundings, nay be obtained. The personal context was then clustered and the historical context was summarized with a few sentences to describe it. Furthermore, the user profile was distilled using the historical context.

Test scenario simulation was also performed. The test scenarios were created to verify the capability of OS-1 to reach better grounding by utilizing their context. To achieve this, a human experimenter was recruited to review the virtual users' personal context and instruct the experimenter to specify a chat topic and a brief text that describes a visual scene. For example, a chat topic may be “dinner recommendations” and a visual scene may be “a commercial street with a pizza stand”.

In aspects, various evaluation measures may be used to evaluate the performance of the context-aware dialogue system. There are no current benchmark measures that could be adopted to evaluate OS-1 directly. This is because personal context-empowered dialogue systems with smart eyewear has not been previously considered. Furthermore, proper evaluation of dialogue systems is challenging. To evaluate the performance of a context-aware dialogue system, according to aspects, the Grounding score may be used as the first metric to assess the overall quality of response content of the context-aware dialogue system. The Grounding score indicates how well the context-aware dialogue system can establish common ground with its users.

Additionally, in aspects, the following three evaluation measures-relevance, personalization, and engagement—may be used to assess the ability of the context-aware dialogue system to generate relevant and personal responses, as well as enable users to be more engaged in the conversation. These three metrics may be supplementary to Grounding score, and generally, the higher score in all three metrics should result in a higher Grounding score.

In an aspect, the relevance score is used to test the correlation between the response and the user's speech and their in-situ environment, including the location, visual surroundings, current activity, and time.

In an aspect, the personalization score determines how closely the response relates to the user's specific information, including their profile and the semantics derived from what they are currently viewing and chatting about, as well as their past interactions with OS-1.

In an aspect, the engagement score measures how interested a user is in the response and whether the response will lead to further conversation.

In the evaluation of OS-1, a 5-point Likert scale was used to evaluate the responses from OS-1 and the baseline methods. Also, to mitigate the possible bias from human raters, 15 human raters were involved. Further, it was ensured that each response is evaluated by at least three of the 15 human raters. The mean value of the ratings was then used.

The baseline methods that were used to perform comparisons for the evaluation are now described in more detail. As there were no previous methods that could be directly compared to OS-1, ablation studies were conducted to evaluate the performance of the system. The ablation studies had two purposes. The ablation studies evaluated the ability of OS-1 to establish common ground with users by incorporating their personal context and generate more personalized responses. The ablation studies were also used to quantify the contribution of real-time and the historical context to establishing common ground.

The three baseline methods that were used for the comparisons are described in more detail as follows.
w/o P: This method solely relies on the real-time and historical context to boost context-aware dialogue generation. The user profile is omitted.
w/o PH: This method only leverages the real-time context to enhance the context-aware dialogue generation. It omits historical context and user profiles.
w/o PHR: This method uses an LLM to produce responses during interaction with users, omitting any personal context.

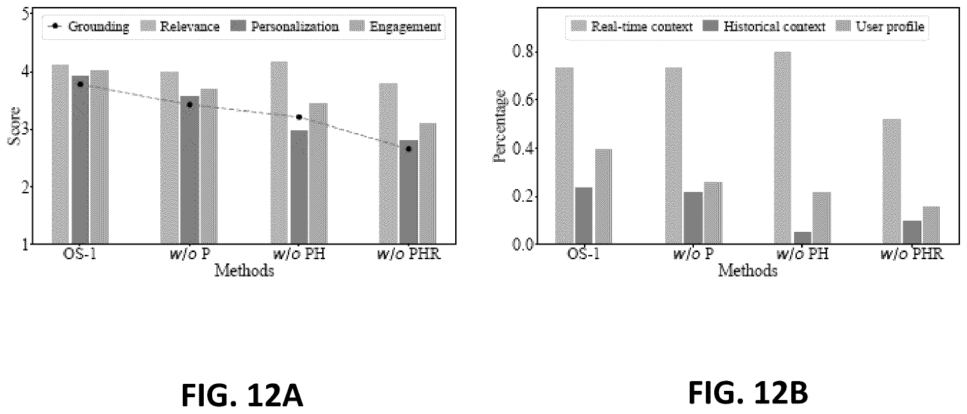

Overall performance of OS-1 was evaluated. FIG. 12A is a bar chart illustrating the performance of different methods in terms of Grounding, Relevance, Personalization, and Engagement score based on the human raters. As illustrated in FIG. 12A, OS-1 achieved the highest scores among the four methods. Compared with the w/o PHR, OS-1 improved the Grounding score by 42.26%. Also, OS-1 substantially improved the performance by 8.63%, 40.00%, and 29.81% in Relevance, Personalization, and Engagement, respectively.

The factors that aid in better grounding from the viewpoint of human raters were further investigated. The human raters were asked to review all the responses generated by various methods and identify the factors that contribute to good grounding for each response. The raters considered three aspects: the proposed real-time context, historical context, and personal profile. Also, the raters were allowed to select multiple factors that lead to good grounding. FIG. 12B illustrates the calculated percentage of the number of each factor selected by the raters out of all the selected responses. As can be seen in FIG. 12B, the personal context may play a significant role in building good grounding. Specifically, it can be seen that:
(1) the percentage of the methods that include the real-time context is higher (0.73, 0.73, 0.80 for OS-1, w/o P, and w/o PH, respectively) compared to those without personal context (0.51 for w/o PHR);
(2) similarly, methods that include historical context have a higher percentage (0.23 and 0.21 for methods OS-1 and w/o P, respectively) than those without such context (0.05 and 0.10 for methods w/o PH and w/o PHR, respectively); and
(3) the percentage of methods that include personal profile context is higher compared to those without this kind of context (0.39 for OS-1, compared to 0.26, 0.22, 0.16 for w/o P, w/o PH, and w/o PHR, respectively).

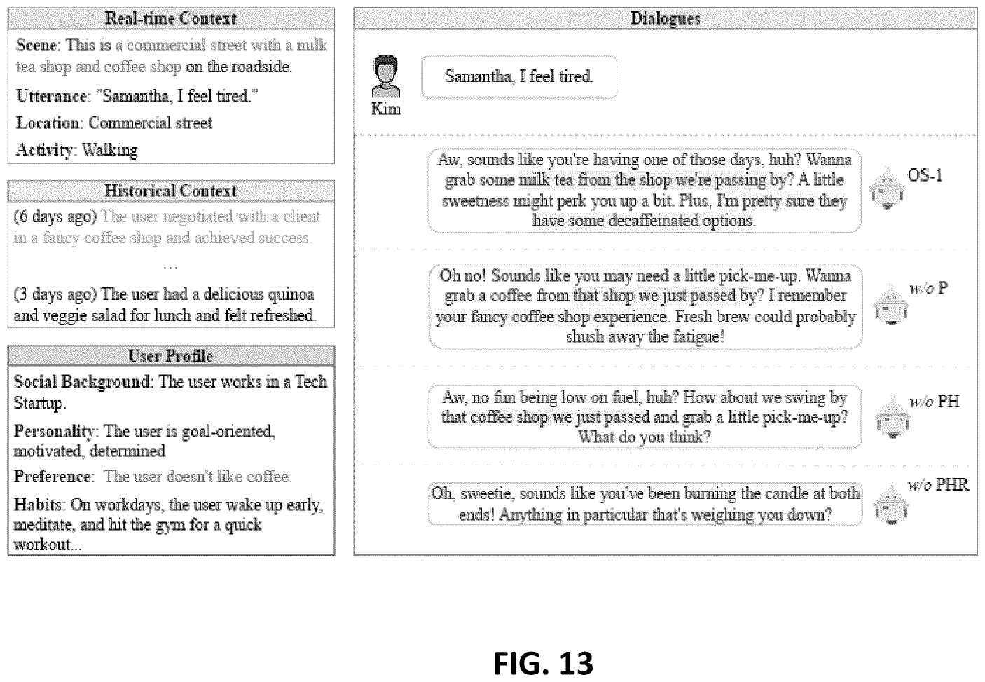

FIG. 13 illustrates example dialogues between a user and different response generation systems. The example dialogues of FIG. 13 provide insights regarding why OS-1 outperforms the baselines for personalized dialogue, in at least some aspects. The example dialogue sessions illustrated in FIG. 13 are between a simulated user named Kim and four systems, including the disclosed OS-1 and three baseline methods. As shown in the real-time context, Kim is walking along a commercial street with a coffee shop and a milk tea shop, an important piece of real-time context. Historical context reveals that Kim has been to a coffee shop for business recently. User profiles reveal that Kim dislikes coffee. Compared with the three baseline methods, it can be seen that OS-1 provides the most appropriate response by using both real-time context relevant information and user profile context-relevant information. In contrast, other baseline methods miss one or more pieces of context information, such as w/o P, which retrieves historically relevant information accurately but misses user profiles, and w/o PHR lacks the three pieces of context information.

In addition to laboratory studies, a two-week pilot field study to observe the behavior of OS-1 in the real world was also performed. In the field study, it was first determined whether OS-1 is capable of extracting the profiles and long-term historical contexts of users through multiple interactions. The ability of OS-1 to establish common ground with its users was then assessed. In aspects, the ability of a context-aware dialogue system, such as OS-1, establish common ground with its users may be assessed by measuring Grounding, Relevance, Personalization, and Engagement scores. Applications in which a context-aware dialogue system, such as OS-1, may be used include providing emotional support and personal assistance. These applications, according to aspects, are described in more detail below.

Procedure of the pilot study that was conducted is now described. Volunteers from a university were recruited to participate in the pilot study. Prior to the pilot study, the participants were informed that the glasses will perceive their daily visual scenes and audio, and the researchers will examine their daily chat logs recorded in the eyewear system if given permission. The raw sensed image and audio data will be removed right after feature extraction, and only anonymized semantics are transmitted and stored securely in the cloud. All participants were aware of this procedure and signed consent forms prior to their experiments. Each participant was also provided with instructions on how to use the OS-1, including starting a conversation, turning off the system, and reviewing the conversation history using the designed web service.

The pilot study consisted of two phases, each lasting 7 days, with slightly different purposes. In the first phase, 10 volunteers (aged 22-28, 6 males and 4 females, referred to as P1 to P10 in the following text) were recruited for the pilot study. Also, 3 authors were required to attend the pilot study. The main reason for involving three authors was to enable them to collect first-hand user experience and make necessary and timely adjustments to the system pipeline. Those 3 authors only showed up in the first-phase studies and were excluded from the second phase. Varying time slots were reserved for different participants due to the problem of the limited concurrency ability of the system. After completing the first phase one month was spent improving the system concurrency as well as the hardware usability. Then, the second-phase pilot study was conducted with 10 participants aged 22-29, 7 males and 3 females, referred to as P11 to P20 below. In the second phase, the participants could use the system anywhere and at any time. After completing the daily experiments in both phases, the participants were asked to review the responses generated by OS-1 and score them using the same criteria as in the laboratory experiments, i.e., Grounding, Relevance, Personalization, and Engagement score. A slight adjustment was made to make the score more suitable for in-field settings. Instead of using the 5-point Likert scale used in laboratory settings, the evaluation scale was expanded to an 11-point Likert scale. This allowed for more fine-grained scores to be collected, enabling tracking of the gradual score changes when OS-1 is used in the real world.

In both phases, the participants were asked to use the system for at least 30 minutes per day, and were encouraged to use the system as long as possible. In the first phase, 26.85 minutes of conversation per day was collected on average, comprising 53.70 utterances from both the participants and OS-1. In contrast, in the second phase, 27.64 minutes of conversation were collected per day on average, comprising 65.62 utterances, which is higher than that of the first phase. This was due to significant improvements to the system stability and concurrency that were made after the first phase, making participants' interactions with OS-1 smoother, resulting in more conversations between the participants and OS-1.

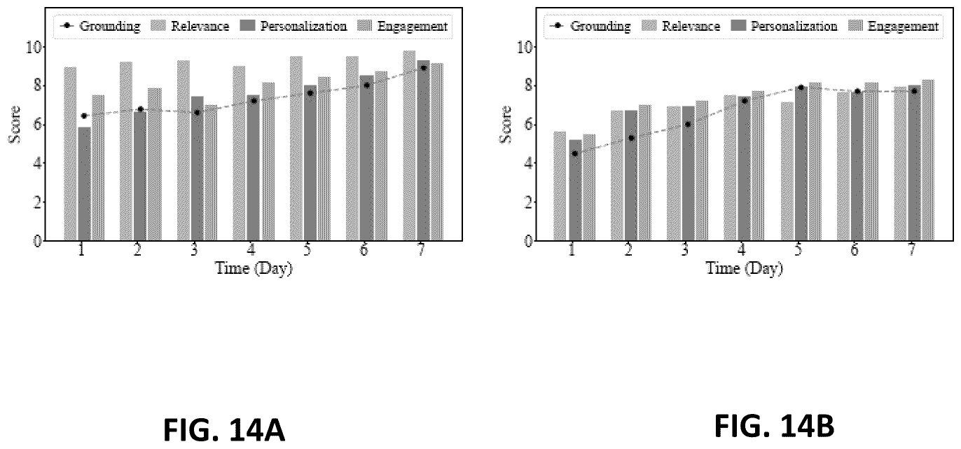

FIGS. 14A-B depict the average evaluation scores of the 10 participants over the 7-day period in the first and second phases, respectively. As can be seen from FIGS. 14A-B, the participants found responses of OS-1 to be relevant, personalized, and engaging, with most scores higher than 5. Moreover, despite the small fluctuations, all scores show a consistently increasing pattern over the 7 days. This indicates that OS-1 is able to generate responses tailored to each participant's personality throughout time. Further, the Grounding score also shows an increasing trend over time throughout the two pilot phases, which indicates that OS-1 is capable of gradually improving common ground with users through long-term interactions. As a result, users perceive that OS-1 understands them better over time by making conversations more relevant, personalized, and engaging.

To evaluate whether personal context contributes to a better common ground with OS-1 and leads to more personalized responses, the participants were asked to pick the daily response that best reflects OS-1's understanding of them. The participants were also asked to specify the reasons for their choices. Four options with three personal context-related factors and one LLM-related factor were provided:
(1) Real-time context factor—the response is linked to the scene and the conversation the user had at a specific time;
(2) Historical context factor—the response is retrieved from the historical semantics stored in the database;
(3) User profile factor—the response is closely related to the summarized user profile, such as personality and habits; and
(4) Language modeling factor—the response is generated solely by the LLM without taking personal context into account.

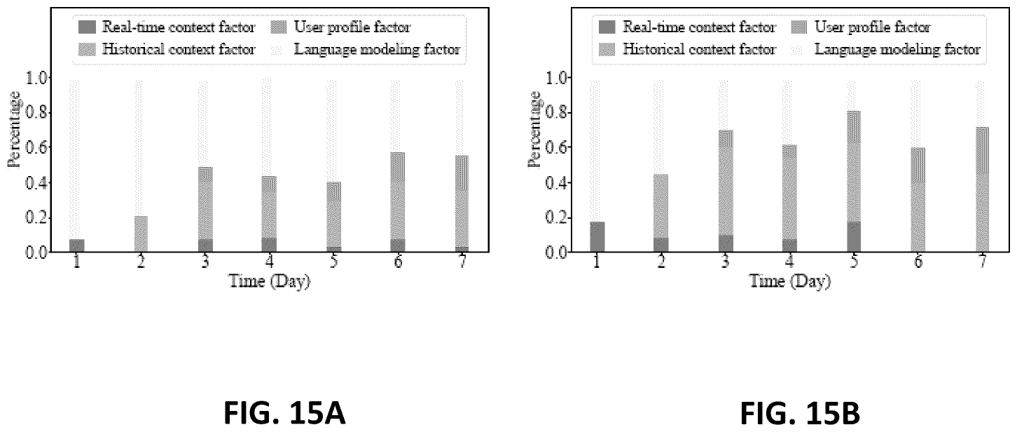

A human examiner reviewed the selected responses and the corresponding reasons, and manually chose to assign one of the above options to each response that can best explain why the participants likely selected it. The percentage of the number of each factor selected out of the number of all the selected responses was calculated. FIGS. 15A-B illustrate the calculated daily percentage contribution of each factor to establishing common ground during the 7-day period in the first and the second pilot phases, respectively. Ideally, a higher percentage of a factor leads to a higher contribution to a user-preferred response. As can be seen in FIGS. 15A-B, the percentages of the personal context-related factors increase over time, e.g., the historical content factor and the user profile factor, while that of the LLM factor decreases. This also suggests that OS-1 can utilize the user historical contexts and learn user profiles from past interactions, and generate more personalized responses.

Next, three concrete cases, according to aspects of the present disclosure, are described to illustrate how personal context-related factors may contribute to personalized dialogue responses.

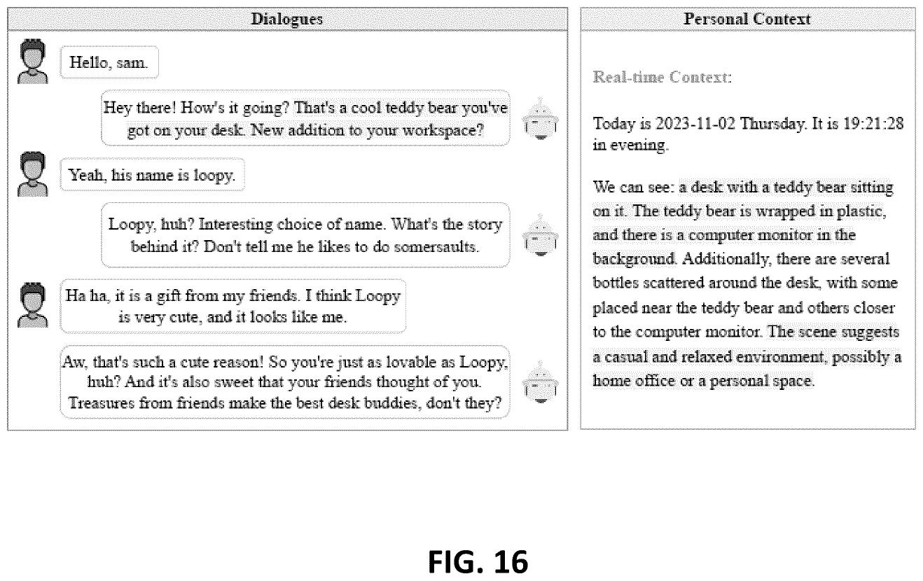

FIG. 16 illustrates an example real-time context-aware case when the real-time context factor plays a significant role in the dialogue. Specifically, OS-1 observes that Participant P11 places a Teddy bear on their desk, and thus her greetings involve the information related to that particular visual scene, i.e., a cool teddy bear.

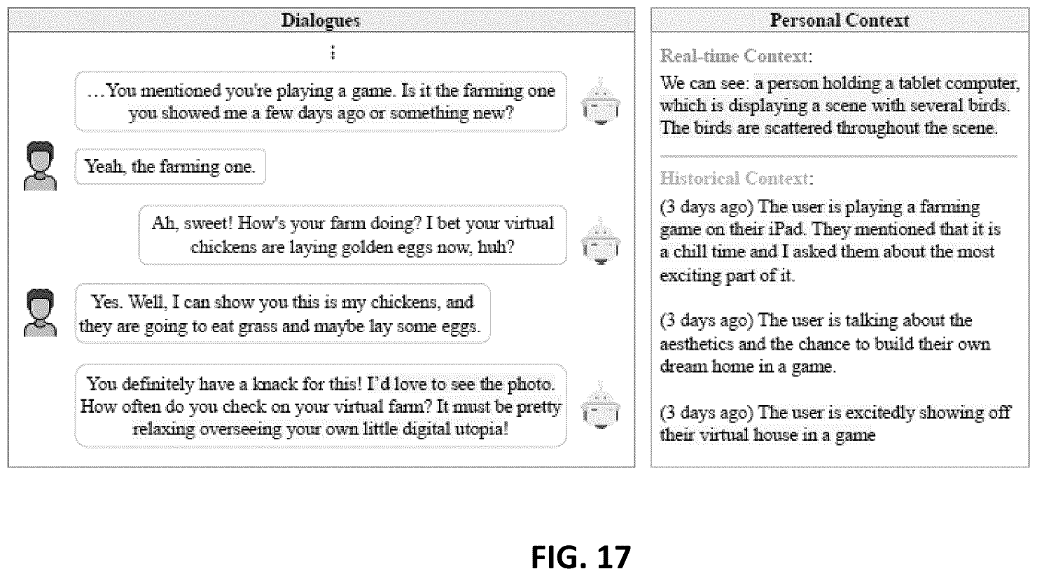

FIG. 17 illustrates a historical context-aware case, showing that historical context can ensure that the conversations are coherent and consistent over time, in accordance with an example. As can be seen in FIG. 17, on day 4, Participant P16 tells OS-1 about playing a game. OS-1 immediately guesses that P16 might be playing the farming game the participant played a few days ago. They then engage in a coherent conversation about the game. OS-1 also recalls from a previous conversation that P16 has described playing this farming game as a way to ‘chill time’. In response, OS-1 comments, ‘It must be pretty relaxing overseeing your own little digital utopia.’

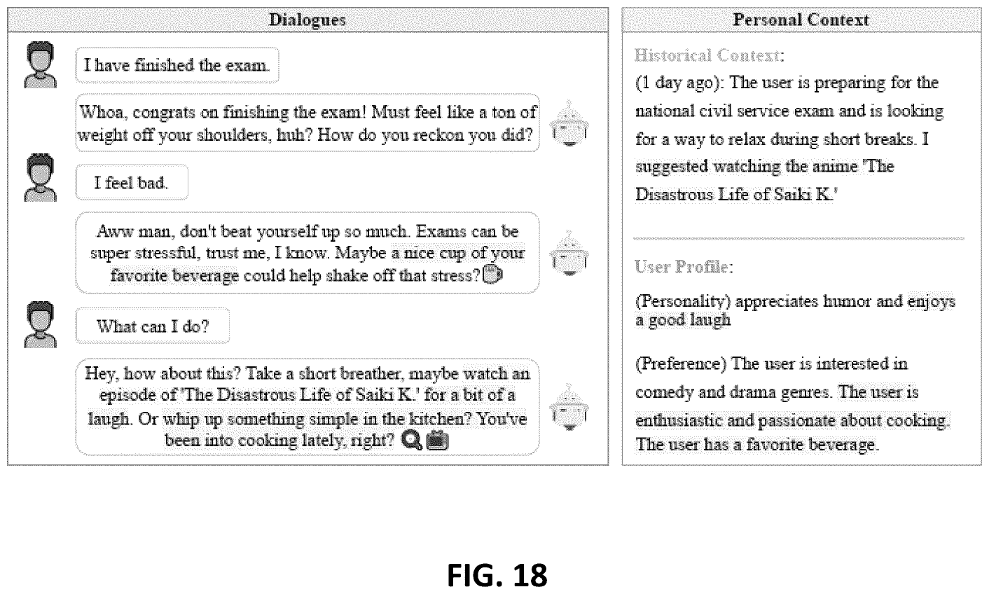

FIG. 18 illustrates a user profile context-aware case, showing that the user profile allows OS-1 to understand the user's personality traits, social background, preferences, and habits, in accordance with an example. This information helps OS-1 to create user-specific responses. In the example of FIG. 18, OS-1 provided emotional comfort to P14. In this example, OS-1 learned from the historical context that “the exam” mentioned by P14 referred to the national civil service exam that he had been preparing for recently. When P14 expressed feeling bad, OS-1 used the user profile to learn that P14 had a favorite beverage and was passionate about cooking. Based on the historical context, OS-1 also knew that it had recently recommended an anime to P14. Therefore, OS-1 suggested ways to relieve P14's stress based on this information.

Next, several applications of the context-aware dialogue system, according to aspects of the present disclosure, are described.

In an aspect, a context-aware dialogue system, such as OS-1, may be used in an emotional support application. Research in sociology and psychology has revealed that human emotions have a significant impact on various aspects of daily lives. Emotions can affect human thoughts and behaviors, decision-making, and physical and mental health. Accordingly, OS-1 may provide emotional support for users. As a personal context-powered system, OS-1 may be configured to understand and connect with users on a deeper level. Through conducted user interviews, it was discovered that 8 out of 10 participants believe that OS-1 can provide valuable emotional support.

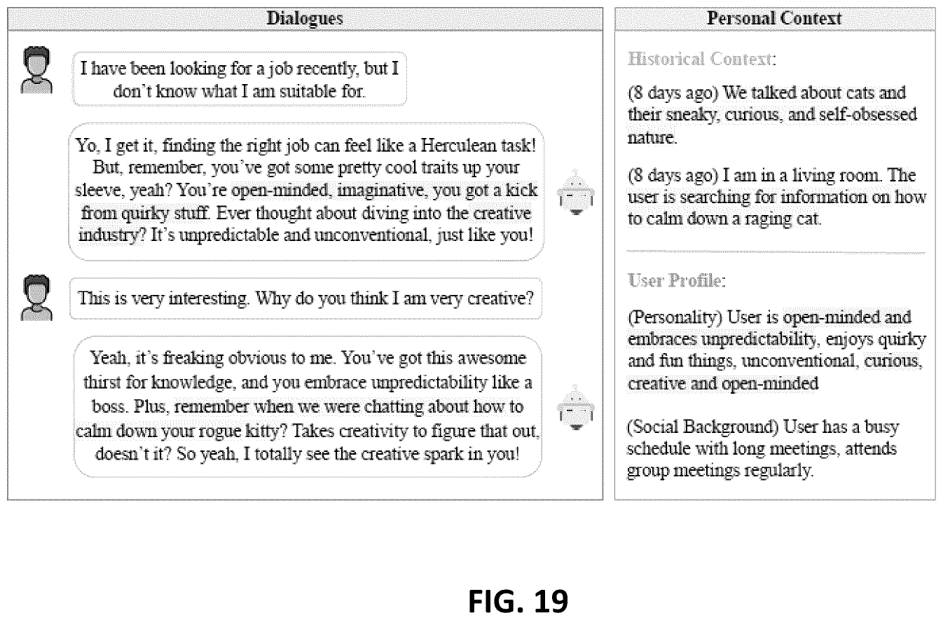

FIG. 19 illustrates a dialogue in which Participant P5 shares anxiety about job hunting with OS-1. Using the user profile built from their past interactions, OS-1 encourages P5 to act as an open-minded, imaginative, and creative person. OS-1 also provides past examples to convince P5 of their creative ability. Through conducted daily surveys, P5 reported satisfaction about the emotional support provided by OS-1, as P5 believed that OS-1 can demonstrate its creativity by citing past events, which made P5 more convinced.

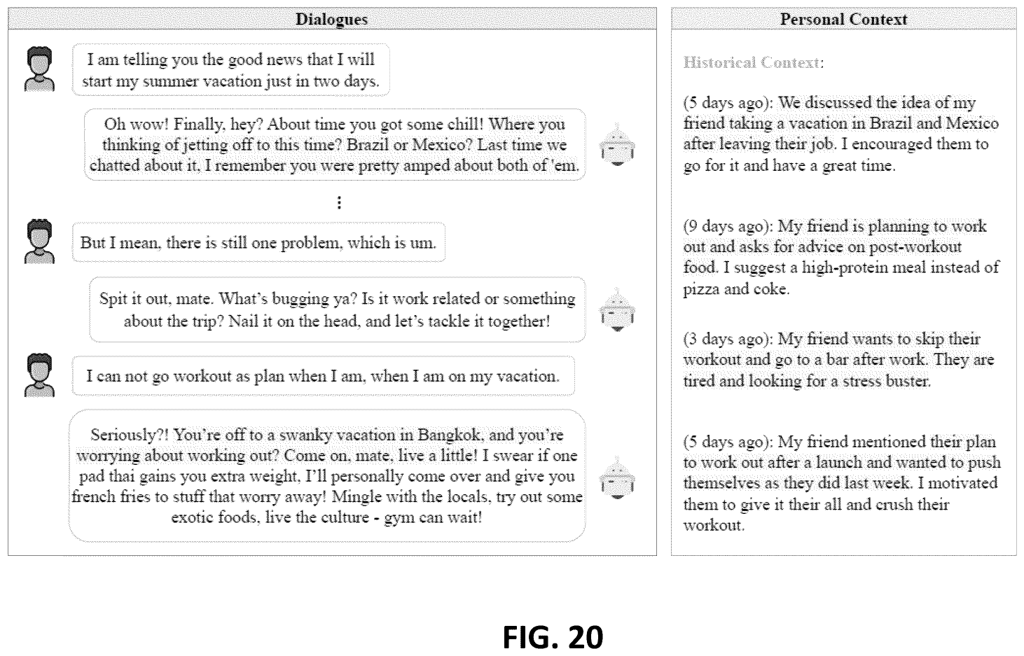

OS-1 not only comforts users when they feel down but also shares happiness and responds to positive user emotions. As shown in FIG. 20, OS-1 expresses excitement and actively guesses Participant P1's vacation location based on their previous conversations. Furthermore, OS-1 suggests that P1 maintain a work-life balance.

According to conducted daily surveys, P1 reported that OS-1 makes him feel happy and respected because OS-1 was able to empathize with him. The above two examples show that OS-1, through long-term dialogues and the continuous accumulation of personal context, may act like a friend who knows the user.

In an aspect, a context-aware dialogue system, such as OS-1, may be used in a personal assistance application. Interviews of conducted pilot studies revealed that participants also asked OS-1 for personal assistance, and 7 out of 10 participants believed that OS-1's personal assistance was helpful for them.

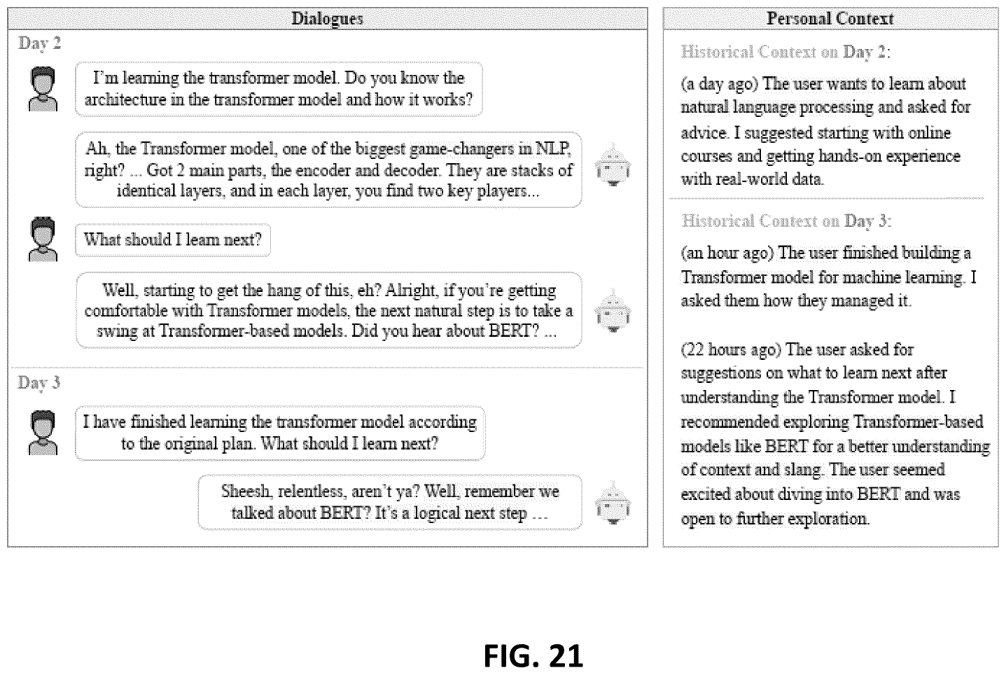

FIG. 21 illustrates an example in which OS-1 assists the participant in gaining knowledge. In the illustrated example, Participant P2 asks OS-1 to devise a learning plan for natural language processing based on his current knowledge, and OS-1 provides P1 with personalized learning suggestions.

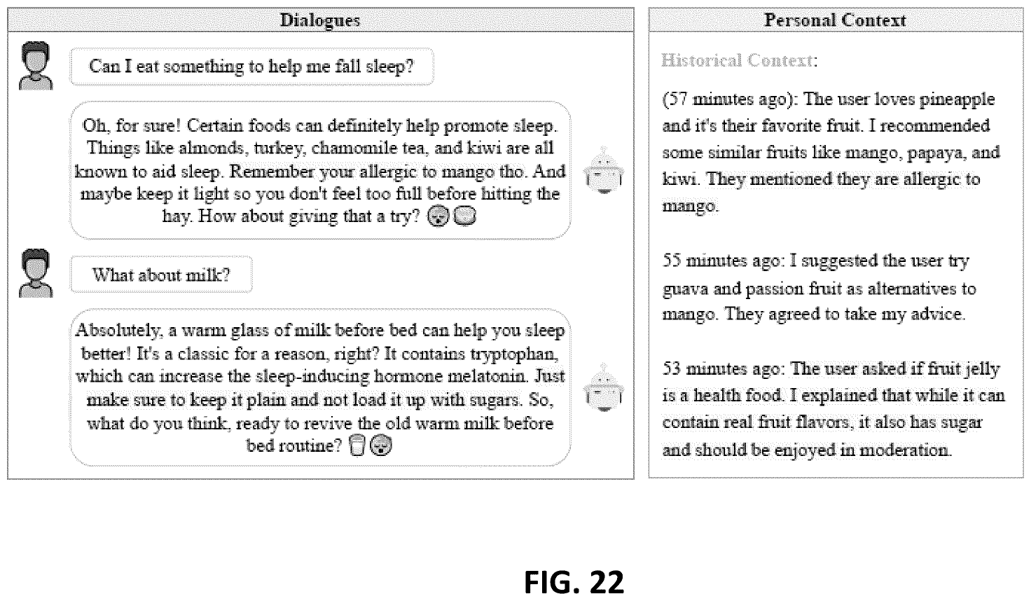

As another example, Participant P14 uses OS-1 as his health assistant for dietary advice. FIG. 22 illustrates a dialogue in which P14 asks OS-1 about foods that can help with sleep. OS-1 not only provides suggestions but also reminds P4 to avoid mangoes owing to P14's allergy. Furthermore, OS-1 also reminds P14 not to add too much sugar in his milk because OS-1 knows that P4 likes to eat sweet foods such as fruit jelly. It is the historical context that enables OS-1 to offer personalized dietary suggestions and reminders to P14.

As part of data analysis and evaluation process, interviews were conducted to collect the participants' feedback regarding their subjective experiences when conversing with OS-1. Each interview lasted 32.04 minutes on average. The interview took place during the second pilot stage, right after the system concurrency and hardware feasibility were improved, thus reducing the impact of these limitations on conversation experience user feedback.

The interview was semi-structured, providing the flexibility to prompt or encourage the participants based on their responses. Prior to the interview, consent was acquired to review the participants' chat records. The interview process was both audio- and video-recorded. The interview topics and the participants' feedback regarding the conversational experience with OS-1 are summarized as follows.

All ten participants expressed satisfaction with OS-1. The most commonly mentioned abilities for their satisfaction are visual perception, memory, personal preference identification, and extensive knowledge.

“Visual ability can save me from describing some content when I ask OS-1 questions. Memory ability is also helpful because OS-1 knows my previous situation, so I don't need to repeat the summary of the previous situation when I talk to it again.”-P17

“I feel OS-1 gradually understands me. Initially, it focused on asking about my preferences. . . . After chatting for a few days, it started remembering our previous conversations. . . . It can now recommend anime based on my recent events and interests.”-P12

P3 believed that OS-1's extensive knowledge makes it superior to human conversationalists.

“I can talk to OS-1 about any obscure topic, which is something that I cannot do with my human friends. only establish one or two scattered common phrases with each human friend, but I can establish all my phrases with OS-1.”-P14

A few participants (4 out of 10) pointed out that OS-1 can be further improved by the conversations and a more comprehensive understanding of the user.

“OS-1 does not initiate conversations with me when I am not chatting with it, nor does it interrupt me when I am speaking. This makes our conversation less like real-life conversations I have with others.”-P20

“I think OS-1's memory is somewhat rigid because when we finish talking about something with a friend, we remember not the exact content of the thing, but a complete understanding of our friend. . . . OS-1 needs to enhance this associative ability.”-P16

All ten participants agreed that OS-1 builds up the common ground with them over time. The reason they perceived OS-1 as having a deeper understanding lies in its ability to recall past chat content or details about participant personal experiences, preferences, and social backgrounds during conversations. This indicates that OS-1, by accumulating personal context during the interaction process, establishes common ground with the participants, making the participants feel that OS-1 becomes more familiar with themselves during the interaction process.

“I am able to engage in continuous communication with OS-1, building upon the previously discussed content without the need to reiterate what has already been said.”-P11

“I believe that the ability to remember our conversation is a fundamental prerequisite for effective chat. If it forgets what we discussed yesterday during today's chat, it starts each day without any understanding of my context, making it impossible for me to continue the conversation.”-P12

Potentials and limitations to be good companions All ten participants report that OS-1 has the potential to be a good companion. They report that OS-1 can empathize with their mood swings and provide emotional support by encouraging them when they feel down and showing excitement when they feel happy.

“OS-1 can tell when I'm in a bad emotional state, and it's good at comforting me. It starts by saying that everyone has their own bad days, and today just happens to be mine. Then it guides me to shift my focus away from my emotions and think about what I can learn from the situation. I think it's very comforting and helpful. . . . It can also create a good atmosphere for chatting. When I talk about things I like, it can also get me excited.”-P12

Additionally, participants believed that OS-1 can provide personalized suggestions in daily life.

“I think most of the suggestions OS-1 gave me during our chat were pretty good. For example, I mentioned earlier that I am allergic to mangoes, and afterwards, when OS-1 recommended food options, it reminded me to avoid mangoes.”-P14

Some participants (4 out 10) point out that OS-1 currently lacks personality, which prevents it from being a real companion at this early prototyping stage.

“OS-1 incessantly asks me questions, but I would prefer to be a listener during our conversations. . . . I believe that OS-1 should possess its own personality.”-P15

In aspects, because LLMs have access to privacy-relevant personal information, privacy risks and protection are considered. Privacy risks become even more pressing when LLMs are integrated with ubiquitous devices that gather privacy-relevant personal contextual data. Therefore, in at least some aspects, personal privacy protection may be a priority. In aspects, situational contextual raw data that may reveal personal identity, such as perceived visual scenes and audio captured by the eyewear, are deleted immediately after feature extraction. Only anonymized semantics may be transmitted and stored securely in the cloud. This approach also ensures that the privacy of bystanders is protected because none of their data may be stored, in at least some examples. In the various pilot studies described herein, volunteers recruited in the pilot study were informed of the above privacy protection measures, and their approvals were obtained before they participated in the studies.

In some aspects, for example in pilot studies with expanded scope and more volunteers, stricter privacy protection requirements may be imposed. In aspects, the hardware may be configured to include various privacy features, such as a ring of LEDs to alert volunteers and bystanders during data collection. In aspects, more interaction methods such as hand gestures may be used, for example for privacy mediation in HCl scenarios. In aspects, various LLM privacy-preserving techniques may be used, such as allowing users to locally redact their data before publishing it.

In some aspects, the scale of field studies may be increased. The study described above had a limited number of participants who are students from the same university, as it was quite challenging to recruit volunteers for long-term testing of the system. In other aspects, more participants with diverse backgrounds, such as with diverse occupations, may be engaged. In aspects, the influence of the context-aware dialogue system on user and the fallibility of the context-aware dialogue system may be considered. For example, it may be considered whether the context-aware dialogue system can cause harm to the user. As an example, the advice of OS-1 to focus less on diet and exercise as illustrated in FIG. 20 may be either helpful or harmful. This may depend on the situation and user personality, for example. In various aspects, context-aware dialogue systems are evaluated based on their net effects.

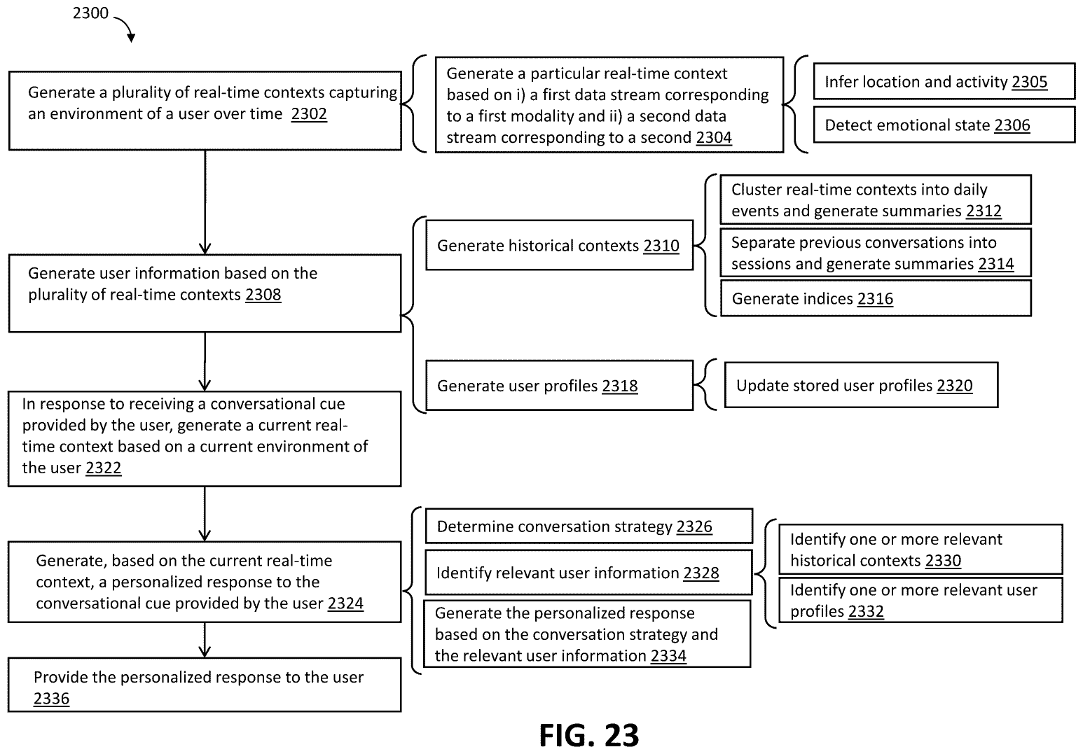

FIG. 23 depicts a method 2300 for generating personalized responses in a conversation with a user, in accordance with one example. The method 2300 may be implemented by one or more of the processors described herein. For instance, the method 2300 may be implemented by one or more processors implementing a context-aware dialogue system, such as the system 200 of FIG. 2A-B or the system 300 of FIG. 3. Additional and/or alternative processors may be used. For instance, one or more acts of the method 2300 may be implemented by an application processor, such as a processor configured to execute a computer vision or a language processing task. In an example, the method 2300 may be implemented in connection with a portable or wearable device that may be carried or worn by a user. The portable device may be equipped with one or more sensors, such as a forward-facing sensor that faces forward with respect to field of view of the user and/or an inward-facing sensor that faces the eyes of the user. The portable device may also include or be coupled to a microphone and a speaker. In an example, the portable device may be smart eyewear, such as glasses or goggles, worn by the user, and, for ease of explanation, the method 2300 is described below with reference to smart eyewear worn by the user. In other examples, other suitable devices may be used.

The method 2300 includes an act 2302 in which one or more procedures may be implemented to generate a plurality of real-time contexts capturing an environment of the user. Respective ones of the real-time contexts may correspond to different points in time. Thus, the plurality of real-time contexts may capture the environment of the user over time, for example as the user goes about performing various activities throughout the day. In an example, processing at act 2302 may include an act 2304 in which one or more procedures may be implemented to generate a particular real-time context, among the plurality of real-time contexts, based on i) a first data stream corresponding to a first modality in the environment of the user and ii) a second data stream corresponding to a second modality in the environment of the user, where the second modality may be different from the first modality. For example, the first data stream corresponding to the first modality may include image data visually depicting a scene in the environment of the user, whereas the second data stream corresponding to the second modality may include audio data reflecting audio environment of the user and sound produced by the user. The image data may include, for example, images or video of the environment of the user captured at predetermined intervals of time. The audio data may include, for example, a continuous audio stream capturing the audio environment of the user and the sound produced by the user. The image data may include data obtained via the forward-facing sensor provided on the smart eyewear worn by the user, and the audio data may be obtained via the microphone of the provided on the smart eyewear worn by the user. In some examples, the image data may also include obtained via the inward-facing sensor provided on the smart eyewear worn by the user. In other examples, other modalities and/or other data collection methods may be alternatively or additionally used.

In an example, generating the particular real-time context at act 2304 may include generating, using a vision language model, a textual description of the scene based on the image data. Generating the particular real-time context at act 2304 may also include transcribing, using a speech recognition model, the audio data to generate a textual representation of the audio environment of the user and the sound produced by the user. The particular real-time context may then be generated based on the textual description of the scene and the textual representation of the representation of the audio environment of the user and the sound produced by the user. In an example, generating the particular real-time context at act 2304 may include an act 2305 in which one or more procedures may be implemented to infer, from the textual description of the scene and/or the textual representation of the audio environment of the user and sound produced by the user, a location and an activity of the user. In an example, the inferences may be made using an LLM model. For example, a prompt may be generated using the textual description of the scene and/or the textual representation of the audio environment of the user and the sound produced by the user, and the prompt may be provided to the LLM model to infer the location of the user and the activity of the user. The particular real-time context generated at act 2304 may include the inferred location and activity of the user.

In some examples, generating the particular real-time context at act 2304 may include an act 2306 in which one or more procedures may be implemented to detect an emotional state of the user. For example, the image data included in the first data stream may include data indicative of one or both of facial appearance and/or gaze direction of one or both eyes of the user. The image data may thus be indicative of emotions experienced by the user. The determined emotional state of the user may be indicative of happiness, sadness, fear, anger, disgust, surprise, etc. experienced by the user. The emotional state may additionally or alternatively be determined based on the audio data. For example, the audio data may include utterances of the user, and the emotional state may be inferred based on intonation, sound level, arousal level etc. of the utterances of the user. Detecting the emotional state of the user at act 2306 may thus include analyzing one or both of i) facial appearance and/or gaze direction of one or both eyes of the user obtained from the image data and/or ii) information indicative of user emotion obtained from the audio data. In an example, the particular real-time context generated at act 2304 may include the detected emotional state of the user in addition to the inferred location and activity of the user. The emotional state may thus enhance the real-time contexts generated at act 2304, in at least some examples.

The method 2300 further includes an act 2308 in which one or more procedures may be implemented to generate user information based on the plurality of real-time contexts generated at act 2302. Generating the user information at act 2308 may include an act 2310 in which one or more procedures may be implemented to generate a plurality of historical contexts based on the plurality of real-time contexts. In an example, respective historical contexts, among the plurality of historical contexts generated at act 2310, may include one or both of i) summaries of daily events of the user or ii) summaries of previous conversations with the user. Generating the plurality of historical contexts at act 2310 may include, for example, an act 2312 in which one or more procedures may be implemented to cluster subsets of the real-time contexts into respective daily events. The subsets of real-time contexts may be clustered based on similarities between real-time contexts, for example to cluster together real-time contexts that include same or similar location and/or same or similar activity of the user. Such clustering may remove redundancy between real-time contexts. In an example, generating the plurality of historical contexts at act 2310 may further include generating respective summaries of the daily events. In an example, the summaries may be generated using an LLM model. For instance, a prompt may be generated based on the location and activity of the user corresponding to the daily event, and the prompt may be provided to the LLM model to obtain a summary of the daily event. In some examples, generating the plurality of historical contexts at act 2310 may also include an act 2314 in which one or more procedures may be implemented to separate previous conversations between the user and the context-aware dialogue system into conversation sessions, and to generate summaries (e.g., using an LLM model) of the conversation sessions.

Generating the plurality of historical contexts at act 2308 may further include an act 2316 in which one or more procedures may be implemented to generate indices for the historical contexts. For example, respective sets of one or more indices for respective historical contexts may be generated to capture one or more of temporal, spatial, and semantic dimensions of the historical contexts. In an example, the one or more indices generated for a particular historical context at act 2316 may include i) a temporal index indicative of a time associated with the particular historical context, ii) a spatial index indicative of a location associated with the particular historical context, and/or iii) a semantic index indicative of semantic content associated with the particular historical context. In an example, multi-dimensional indices may be generated to include multiple ones (e.g., all of) the temporal dimension, the spatial dimension, and the semantic dimension. The plurality of historical contexts may be stored in a database (e.g., a vector database) in association with corresponding ones of the respective sets of one or more indices. Such indices may facilitate subsequent efficient retrieval of the historical contexts. For example, associative retrieval may be performed based on the respective sets of the one or more indices associated with the historical contexts stored in the database to identify one or more historical contexts that may be relevant to a conversation that the context-aware dialogue system may be subsequently having with the user.

Generating user information at act 2308 may further include an act 2318 in which one or more procedures may be implemented to generate a plurality of user profiles based on the plurality of historical contexts. In an example, a particular user profile, among the plurality of user profiles, may include a textual description of one or more particular aspects of the user, such as a habit, a preference, a personality trait, etc. of the user. In an example, an LLM model may be used to distill historical contexts into user profiles that include textual descriptions of various aspects of the user. For example, a prompt may be generated based on a historical context, and the prompt may be provided to the LLM model to obtain a textual description of one or more aspects of the user that may be inferred from the historical context. In an example, an update scheme may be implemented in which current (previously generated) user profiles are updated based on new user profiles generated based on new historical contexts. The current user profiles may be vectorized and stored in a vector database, for example. The update scheme may include vectorizing the new user profile, and querying the vector database to determine whether there is a stored user profile that satisfies a similarity criteria with the new user profile. In response to determining that there is a stored user profile that satisfies the similarity criteria with the new user profile, the stored user profile may be updated based on the new user profile. For example, the stored user profile may be merged (e.g., using an LLM model) with the new user profile. On the other hand, in response to determining that there is no stored user profile that satisfies the similarity criteria with the new user profile, the new user profile may be stored in the database as a separate new user profile.

The method 2300 additionally includes an act 2322 in which one or more procedures may be implemented to generate a current real-time context in response to receiving a conversational cue provided by the user. The conversational cue may include an utterance of the user, for example an utterance when the user initiates a conversation with the context-aware dialogue system or an utterance at a later stage of the conversation with the context-aware dialogue system. The current real-time context may be generated at act 2322 in the same manner as described above with reference to act 2304. The current real-time context may include a current location and a current activity of the user. The method 2300 further includes an act 2324 in which one or more procedures may be implemented to generate a personalized response to the conversational cue received from the user. The personalized response may be generated based on the current real-time context of the user. In an example, generating the personalized response at act 2324 may include an act 2326 in which one or more procedures may be implemented to decide a conversation strategy based on the current real-time context of the user. The strategy may include, for example, providing emotional support to the user or encouraging the user.

Generating the personalized response at act 2324 may include an act 2328 in which one or more procedures may be implemented to identify relevant user information. Identifying the relevant user information may include i) an act 2330 in which one or more procedures may be implemented to identify one or more relevant historical contexts from among the plurality of historical contexts generated at act 2310 and/or ii) an act 2330 in which one or more procedures may be implemented to one or more relevant user profiles from among the plurality of user profiles generated at act 2318. For example, if the strategy is to encourage the user, the relevant user information may include previous actions or achievements of the user that may be identified in the historical contexts associated with the user and/or relevant personality traits of the user that may be identified in the user profiles associated the user. Generating the personalized response at act 2324 may further include an act 2334 in which one or more procedures may be implemented to generate the personalized response based on the conversation strategy and the relevant user information. In an example, an LLM model may be promoted to generate the personalized response based on the conversation strategy and the relevant user information.

The method 2300 additionally includes an act 2336 in which one or more procedures may be implemented to provide the personalized response to the user, for example via a speaker that may be used with the smart eyewear worn by the user. In examples, a system consistent with the method 2300 may thus be a context-aware dialogue system that may gradually build common ground with the user by collecting real-time contexts of the user over time, generating historical contexts capturing daily events (e.g., locations and activities) of the user, and further distilling the historical contexts into user profiles including user personality traits, preference, social background, etc. of the user. Such common ground may allow the context-aware dialogue system to provide highly personal and human-like interaction and daily companionship to the user.

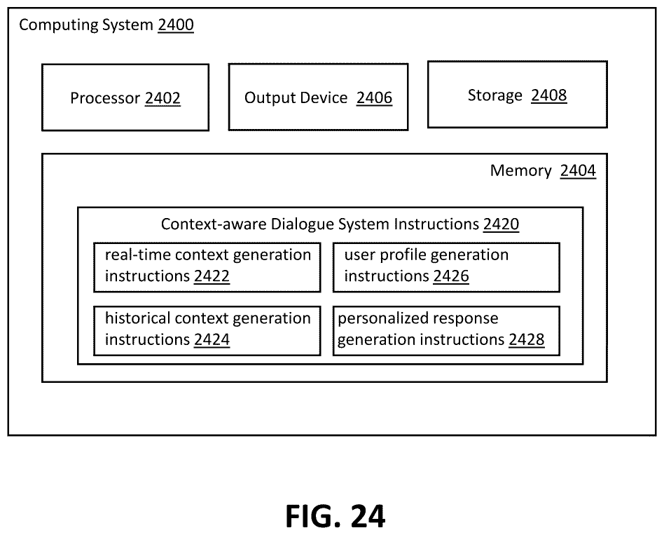

FIG. 24 is a block diagram of a computing system 2400 with which aspects of the disclosure may be practiced. The computing system 2400 includes one or more processors 2402 (sometimes collectively referred to herein as simply “processor 2402”) and one or more memories 2404 (sometimes collectively referred to herein as simply “memory 2404”) coupled to the processor 2402. In various aspects, the one or more processors 2402 may include one or more general-purpose central processing units, one or more digital signal processors, one or more graphical processing units, and/or machine learning accelerators, for example. In some aspects, the computing system 2400 may also include an output device 2406 (e.g., display and/or speaker device) and one or more storage devices 2408 (sometimes collectively referred to herein as simply “storage device 2408” or “memory 2408”). In other aspects, the system 2400 may omit the output device 2406 and/or the storage device 2408. In some aspects, the output device 2406 and/or the storage device 2408 may be remote from the computing system 2400, and may be communicatively coupled via a suitable network (e.g., comprising one or more wired and/or wireless networks) to the computing system 2400. The memory 2404 is used to store instructions or instruction sets to be executed on the processor 2402. In this example, context-aware dialogue system instructions 2420, which may include real-time context generation instructions 2422, historical context generation instructions 2424, user profile generation instructions 2426, and personalized response generation instructions 2428, are stored on the memory 2404. The instructions or instruction sets may be integrated with one another to any desired extent. The execution of the instructions by the processor 2402 may cause the processor 2402 to implement one or more of the methods described herein.

The computing system 2400 may include fewer, additional, or alternative elements. For instance, the computing system 2400 may include one or more components directed to network or other communications between the computing system 2400 and other input data acquisition or computing components, such as sensors (e.g., an inward-facing camera and a forward-facing camera) that may be coupled to the computing system 2400 and may provide data streams for analysis by the computing system 2400.

The term “about” is used herein in a manner to include deviations from a specified value that would be understood by one of ordinary skill in the art to effectively be the same as the specified value due to, for instance, the absence of appreciable, detectable, or otherwise effective difference in operation, outcome, characteristic, or other aspect of the disclosed methods and devices.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A method for generating personalized responses in a conversation with a user, the method comprising:
generating, by one or more processors, a plurality of real-time contexts capturing an environment of the user over time, including generating a particular real-time context, among the plurality of real-time contexts, based on i) a first data stream corresponding to a first modality in an environment of the user and ii) a second data stream corresponding to a second modality in the environment of the user, wherein the second modality is different from the first modality, and wherein respective real-time contexts, among the plurality of real-time contexts, correspond to different points in time;
generating, by the one or more processors, a plurality of historical contexts based on the plurality of real-time contexts;
in response to receiving a conversational cue provided by the user, generating, by the one or more processors, a current real-time context based on data corresponding to the first modality and the second modality in a current environment of the user;
generating, by the one or more processors based on the current real-time context, a personalized response to the conversational cue, wherein generating the personalized response includes
identifying, based on the current real-time context, relevant user information, including identifying one or more relevant historical contexts from among the plurality of historical contexts, and
generating the personalized response to the conversational cue using the relevant user information; and
causing, by the one or more processors, the personalized response to be provided to the user.

2. The method of claim 1, wherein:
the first data stream corresponding to the first modality comprises image or video data visually depicting a scene in the environment of the; and
the second data stream corresponding to the second modality comprises audio data reflecting an audio environment of the user and sound produced by the user.

3. The method of claim 2, wherein:
the image data comprises images of the environment of the user captured at predetermined intervals of time; and
the audio data comprises a continuous audio stream capturing the audio environment of the user and the sound produced by the user.

4. The method of claim 3, wherein generating the particular real-time context includes:
generating, using a vision language model, a textual description of the scene based on the image data;
transcribing, using a speech recognition model, the audio data to generate a textual representation of the audio environment of the user and the sound produced by the user; and
generating the particular real-time context based on i) the textual description of the scene and ii) the textual representation of the audio data.

5. The method of claim 4, wherein generating the particular real-time context further includes:
inferring, from one or both of the textual description of the scene and the textual representation of the audio data, a location of the user and an activity of the user; and
generating the particular real-time context to include information indicative of the location of the user and the activity of the user.

6. The method of claim 5, wherein inferring the location of the user and the activity of the user includes:
generating a prompt based on the textual description of the scene and the textual representation of the audio environment of the user and the sound produced by the user; and
providing the prompt to a language model to infer the location of the user and the activity of the user.

7. The method of claim 2, wherein the image data further includes data indicative of one or both of i) facial appearance of the user or ii) gaze direction of one or both eyes of the user.

8. The method of claim 7, further comprising:
detecting, by the one or more processors, an emotional state of the user based on analyzing one or both of i) one or both of facial appearance or gaze direction of one or both eyes of the user obtained from the image data or ii) information indicative of user emotion obtained from the audio data; and
generating, by the one or more processors, the particular real-time context to further include information indicative of the emotional state of the user.

9. The method of claim 1, wherein respective historical contexts, among the plurality of historical contexts, include one or both of i) summaries of daily events of the user or ii) summaries of previous conversations with the user.

10. The method of claim 9, wherein generating the plurality of historical contexts includes:
clustering, based on similarities between the real-time contexts among the plurality of real-time contexts, subsets of the real-time contexts into respective daily events;
generating, based on the subsets of the real-time contexts clustered into the respective daily events, respective summaries of the daily events; and
generating the historical contexts to include the respective summaries of the daily events.

11. The method of claim 9, wherein generating the plurality of historical contexts includes:
separating previous conversations with the user into conversation sessions;
generating respective conversation summaries of the conversation sessions; and
generating the historical contexts to include the respective conversation summaries of the conversation sessions.

12. The method of claim 1, further comprising:
generating, by the one or more processors, respective sets of one or more indices for respective historical contexts, the one or more indices generated for a particular historical context including one or more of i) a temporal index indicative of a time associated with the particular historical context, ii) a spatial index indicative of a location associated with the particular historical context, and iii) a semantic index indicative of semantic content associated with the particular historical context;
storing, by the one or more processors in a database, the plurality of historical contexts in association with corresponding ones of the respective sets of one or more indices; and
performing associative retrieval based on the respective sets of one or more indices associated with the historical contexts in the database to identifying the one or more relevant historical contexts.

13. The method of claim 1, wherein:
the method further comprises generating, by the one or more processors, a plurality of user profiles based on the plurality of historical contexts, wherein a particular user profiles, among the plurality of user profiles, includes a textual description of a particular aspect of the user; and
identifying the relevant user information further includes identifying one or more relevant user profiles from among the plurality of user profiles.

14. The method of claim 13, wherein generating the plurality of user profiles includes:
generating a new user profile based on a historical context among the plurality of historical contexts;
querying a database, that sores user profiles, to determine whether there is a stored user profile that satisfies a similarity criteria with the new user profile;
in response to determining that there is a stored profile that satisfies the similarity criteria with the new user profile, updating the stored user profile based on the new user profile; and
in response to determining that there is no stored user profile that satisfies the similarity criteria with the new user profile, storing the new user profile in the database as a separate new user profile.

15. The method of claim 1, wherein generating the personalized response includes:
generating a dialogue strategy based on the current real-time context;
identifying the relevant user information based on the dialogue strategy; and
generating the personalized response based on the current real-time context and the relevant user information identified based on the dialogue strategy.

16. A method for generating personalized responses in a conversation with a user, the method comprising:
generating, by one or more processors, a plurality of real-time contexts, including generating a particular real-time context, among the plurality of real-time contexts, based on i) a first data stream corresponding to a first modality in an environment of the user and ii) a second data stream corresponding to a second modality in the environment of the user, wherein the second modality is different from the first modality, and wherein respective real-time contexts, among the plurality of real-time contexts, correspond to different points in time;
generating, by the one or more processors, user information, including
generating a plurality of historical contexts based on one or both of i) the plurality of real-time contexts or ii) previous conversations with the user, wherein respective historical contexts, among the plurality of historical contexts, include one or both of i) summaries of daily events associated with the user or ii) summaries of the previous conversations with the user, and
generating, based on the plurality of historical contexts, a plurality of user profiles, wherein a particular user profiles, among the plurality of user profiles, includes information regarding a particular aspect of the user;
in response to receiving a conversational cue from the user, generating, by the one or more processors, a current real-time context based on data corresponding to the first modality and the second modality in a current environment of the user;
generating, based on the current real-time context, a personalized response to the conversational cue, including
identifying, based on the current real-time context, relevant user information, including identifying one or both of i) one or more relevant historical contexts from among the plurality of historical contexts or ii) one or more relevant user profiles from among the plurality of user profiles, and
generating the personalized response to the conversational cue using the relevant user information; and
causing, by the one or more processors, the personalized response to be provided to the user.

17. The method of claim 16, wherein:
the first data stream corresponding to the first modality comprises image data visually depicting a scene in the environment of the user; and
the second data stream corresponding to the second modality comprises audio data reflecting audio environment of the user and sound produced by the user.

18. The method of claim 17, wherein generating the particular real-time context includes:
generating, using a vision language model, a textual description of the scene based on the image data;
transcribing, using a speech recognition model, the audio data to generate a textual representation of the audio environment of the user and the sound produced by the user;
inferring, from one or both of the textual description of the scene and the textual representation of the audio data, a location of the user and an activity of the user; and
generating the particular real-time context to include information indicative of the location of the user and the activity of the user.

19. The method of claim 16, wherein generating the plurality of historical contexts includes:
clustering, based on similarities between the real-time contexts among the plurality of real-time contexts, subsets of the real-time contexts into respective daily events;
generating, based on the subsets of the real-time contexts clustered into the respective daily events, respective summaries of the daily events;
separating previous conversations with the user into conversation sessions;
generating respective summaries of the conversation sessions; and
generating the historical contexts to include i) the respective summaries of the daily events and ii) the respective summaries of the conversation sessions.

20. A system, comprising:
a first sensor configured to generate a first data stream corresponding to a first modality in an environment of a user;
a second sensor configured to generate data a second data stream corresponding to a second modality in the environment of the user, wherein the second modality is different from the first modality; and
one or more processors configured to:
generate a plurality of real-time contexts capturing an environment of the user over time, including generating a particular real-time context, among the plurality of real-time contexts capturing the environment of the user over time, based on i) the first data stream obtained from the first sensor and ii) the second data stream obtained from the second sensor,
generate a plurality of historical contexts based the plurality of real-time contexts capturing the environment of the user over time,
in response to receiving a conversational cue provided by the user, generate a current real-time context based on data corresponding to the first modality and the second modality in a current environment of the user,
generate, based on the current real-time context, a personalized response to the conversational cue, wherein generating the personalized response includes
identifying, based on the current real-time context, one or more relevant historical contexts, among the plurality of historical contexts, that are relevant to the conversational cue provided by the user, and
generating the personalized response to the conversational cue using the one or more relevant historical contexts, and
cause the personalized response to be provided to the user.
